(19) United States
(12) Patent Application Publication
(10) Pub. No.: US 2018/0314609 A1
(43) Pub. Date: Nov. 1, 2018

(54) APPARATUS AND METHOD TO SUPPRESS DATA ACCESSES CAUSED BY CHANGE IN DISTRIBUTED DATA LAYOUT OF STORAGES

(71) Applicant: FUJITSU LIMITED, Kawasaki-shi (JP)

(72) Inventors: Chikashi Maeda, Kawasaki (JP); Yukari Tsuchiyama, Kawasaki (JP); Guangyu ZHOU, Kawasaki (JP)

(73) Assignee: FUJITSU LIMITED, Kawasaki-shi (JP)

(21) Appl. No.: 15/944,922

(22) Filed: Apr. 4, 2018

(30) Foreign Application Priority Data
Apr. 27, 2017 (JP) 2017-088709

(51) Int. Cl. G06F 11/20; G06F 11/16; G06F 11/14; G06F 11/10; G06F 3/06

(52) U.S. Cl. CPC G06F 11/2094; G06F 11/1662; G06F 11/1469; G06F 3/0689; G06F 3/0631; G06F 3/0619; G06F 11/1092

(57) ABSTRACT

An apparatus stores recovery data of a fast recovery portion of storage data in different portions of a plurality of storages, and stores the recovery data in different fast recovery bands within a physical address range of each of the plurality of storages, where the physical address range is divided according to a size of the fast recovery portion. The apparatus transfers recovery data having different addresses from a redundancy set corresponding to a number of divisions in the physical address range to data transfer target storage.

### CROSS-REFERENCE TO RELATED APPLICATION

This application is based upon and claims the benefit of priority of the prior Japanese Patent Application No. 2017-88709, filed on Apr. 27, 2017, the entire contents of which are incorporated herein by reference.

### FIELD

The embodiment discussed herein is related to apparatus and method to suppress data accesses caused by change in distributed data layout of storages.

### BACKGROUND

Conventionally, there is a redundant arrays of inexpensive disks (RAID) technique that combines a plurality of storages and operates as a virtual disk. In order to reduce a time taken for data recovery, there is a technique that distributes respective data included in a dataset ensuring redundancy with respective data of any of two or more numbers. When an alternative storage corresponding to the storage is held in an energized state and the storage fails, there is a technique that uses the alternative storage referred to as a hot spare instead of the failed storage.

In related art, for example, a table that stores mapping information between a logic address as a disk array after disk addition and a physical address of each disk is created, and mapping information between a logic address and a physical address used before the disk addition is stored in the table. There is a technique of alternatively using a spare area of another disk when spare areas are disposed in a recording area of each disk in a distributed manner and one disk fails, and of performing data restoration excluding the spare area when the disk is replaced.

Japanese Laid-open Patent Publication Nos. 2000-010738 and 2000-200157 are examples of the related art.

### SUMMARY

According to an aspect of the invention, upon determination to perform a distributed layout change in which a new storage or a hot-spare storage to be a hot spare is added to a plurality of storages, in a state where redundancy datasets each including two or more pieces of data which ensure redundancy of the data are stored in the plurality of storages so that the two or more pieces of data are respectively disposed on different storages of the plurality of storages and respectively disposed at different physical addresses within a physical address range that is allocated in common to each of the plurality of storages, an apparatus selects, from among the redundancy datasets, a first redundancy dataset including two or more pieces of first data that are respectively disposed on first different storages of the plurality of storages and respectively disposed at first different physical addresses within the physical address range, where the different physical addresses are obtained by dividing the physical address range according to a data size of each of the two or more pieces of data. The apparatus transfers the two or more pieces of first data included in the selected first redundancy dataset to second different physical addresses on the new storage or the hot-spare storage, respectively, so that the second different physical addresses are identical to the first different physical addresses within the physical address range allocated to the plurality of storages.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an explanatory diagram illustrating an operation example of a storage control apparatus according to a present embodiment;

FIG. 2 is an explanatory diagram illustrating a configuration example of a storage system;

FIG. 3 is an explanatory diagram illustrating a hardware configuration example of a CM;

FIG. 4 is an explanatory diagram illustrating a disk pool configuration example according to the present embodiment;

FIG. 5 is an explanatory diagram illustrating a function configuration example of the CM;

FIG. 6 is an explanatory diagram illustrating an example of storage contents of a distributed layout table;

FIG. 7 is an explanatory diagram illustrating an operation example of a Rebuild process;

FIG. 8 is an explanatory diagram illustrating an operation example of a Rebalance process;

FIG. 9 is a flowchart (part 1) illustrating an example of a disk pool creation process procedure;

FIG. 10 is a flowchart (part 2) illustrating an example of the disk pool creation process procedure;

FIG. 11 is an explanatory diagram illustrating an example of storage contents of a FHS selection table;

FIG. 12 is an explanatory example (part 1) illustrating update examples of the distributed layout table and a distributed management table in a disk pool process;

FIG. 13 is an explanatory example (part 2) illustrating update examples of the distributed layout table and the distributed management table in the disk pool process;

FIG. 14 is a flowchart (part 1) illustrating an example of a Rebuild process procedure;

FIG. 15 is a flowchart (part 2) illustrating an example of the Rebuild process procedure;

FIG. 16 is a flowchart illustrating an example of a disk addition process procedure;

FIG. 17 is a flowchart illustrating an example of a FHS setting process procedure in FR-WideBand;

FIG. 18 is a flowchart illustrating an example of a FR-Unit setting process procedure in FR-Band;

FIG. 19 is an explanatory diagram illustrating an example of a disk pool configuration in which configuration components of a redundancy set are disposed at the same position on disks;

FIG. 20 is an explanatory diagram illustrating an example of a disk pool configuration in which configuration components of a redundancy set are managed by a disk number and a position on a disk; and

FIG. 21 is an explanatory diagram illustrating an example of effects according to the present embodiment.

### DESCRIPTION OF EMBODIMENT

According to the related arts, in some cases, when new storage is added to the plurality of storages controlled by the RAID technique or when there is an instruction to transfer data to the hot spare, data replacement occurs when changing a distributed layout of data. When the data replacement occurs, reading and writing to a temporary work buffer area for the data replacement occurs. Therefore, the number of data accesses increases.

It is preferable to suppress the number of data accesses when changing the distributed layout of data of the plurality of storages controlled by the RAID technique.

Hereinafter, an embodiment of a disclosed storage control apparatus, a storage control method, and a storage control program will be described in detail with reference to the following drawings.

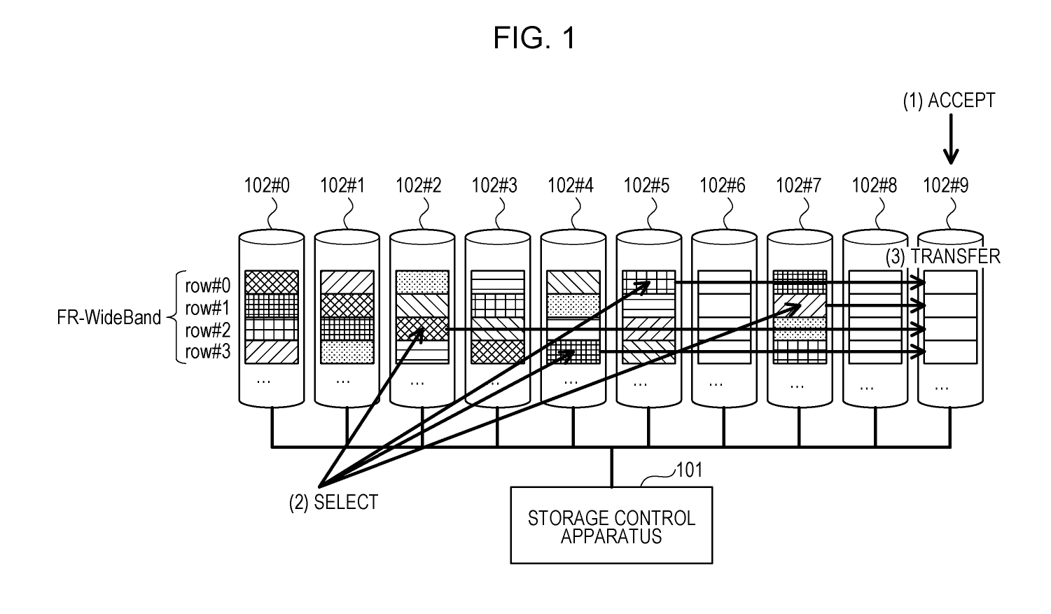

FIG. 1 is an explanatory diagram illustrating an operation example of a storage control apparatus 101 according to the present embodiment. The storage control apparatus 101 is a computer that controls a plurality of storages. Specifically, the storage control apparatus 101 generates a virtual disk by a RAID technique with the plurality of storages and provides the generated disk to a user of the storage control apparatus 101.

The RAID technique is a technique that combines the plurality of storages and operates as the virtual disk. Here, in the RAID, there is a RAID level representing a method of forming the virtual disk. A virtual disk formed by a RAID level of RAID 1 or higher has redundancy, and data can be recovered from other storages even when some storages fail. Hereinafter, a process that recovers the data is referred to as “Rebuild process”.

When an alternative storage corresponding to the storage is held in an energized state and the storage fails, there is a technique that uses the alternative storage instead of the failed storage. Hereinafter, the alternative storage is referred to as “hot spare (HS)”.

Here, an improvement rate of an access speed to a disk is limited as compared with a capacity expansion rate of a disk alone. Therefore, a time desired for the Rebuild process at a time of disk failure in a RAID configuration increases year by year.

Here, in order to reduce the time taken for the Rebuild process, it can be considered that datasets ensuring the redundancy of data and hot spare areas are disposed in the RAID in a distributed manner. Hereinafter, the dataset ensuring the redundancy of data is referred to as “redundancy set”. In the distributed disposition described above, when the disk failure occurs, it is considered that data is read from each disk in which the data included in a redundancy set of a recovery target is stored in order to recover the data, and the recovered data is written in the hot spares on the plurality of storages. The RAID configuration in which the redundancy sets and the hot spare areas are disposed in a distributed manner may be referred to as a “Fast Recovery RAID” configuration. Hereinafter, the RAID configuration in which the redundancy sets and the hot spare areas are disposed in a distributed manner is referred to as “disk pool configuration”.

In the disk pool configuration, a fast recovery (FR)-Depth, a FR-Unit, a FR-Band, and a fast hot spare (FHS) are defined. The FR-Depth is a physical storage area having the same capacity as a data division unit of a redundancy set. For example, in a redundancy set of RAID 5 formed by three user data and one piece of parity data, the redundancy set is stored in four FR-Depths.

The FR-Unit is FR-Depths with any of two or more numbers. Accordingly, the FR-Unit is a unit ensuring the redundancy. Hereinafter, the number of FR-Depths included in the FR-Unit may be referred to as “the number of divisions”. The FR-Depths belonging to the same FR-Unit are not disposed in the same storage in order not to reduce the redundancy.

The FR-Band is a set of FR-Bands having the same physical address through storages belonging to the disk pool configuration. A xth FR-Band may be expressed by row#x.

The FHS is a saving area of data stored in each FR-Band and stored in a FR-Depth belonging to the FR-Band. The FHS is the same size as the FR-Depth. There may be one or more FHSs in the FR-Band.

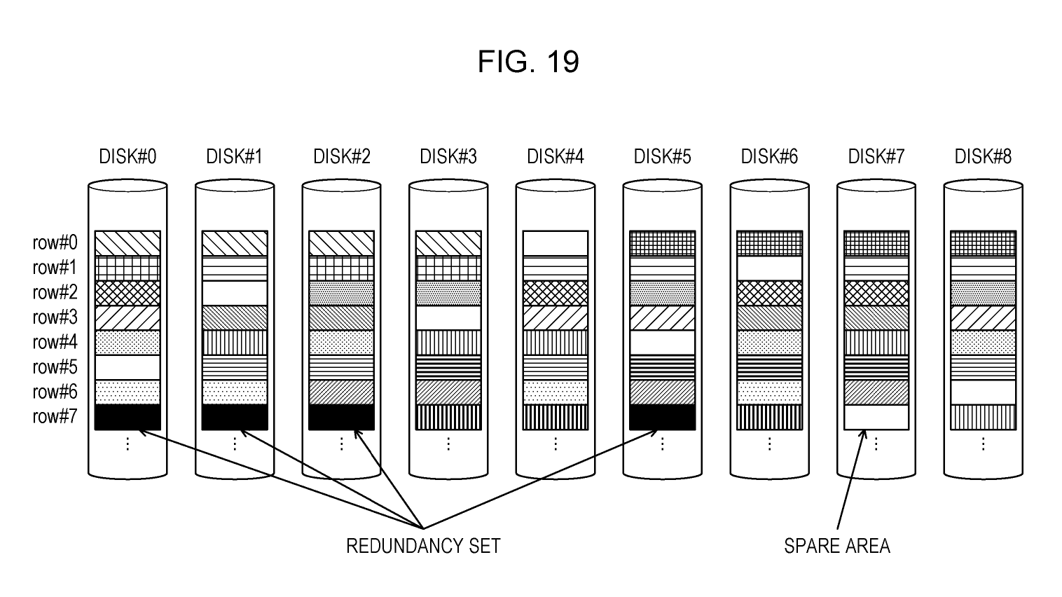

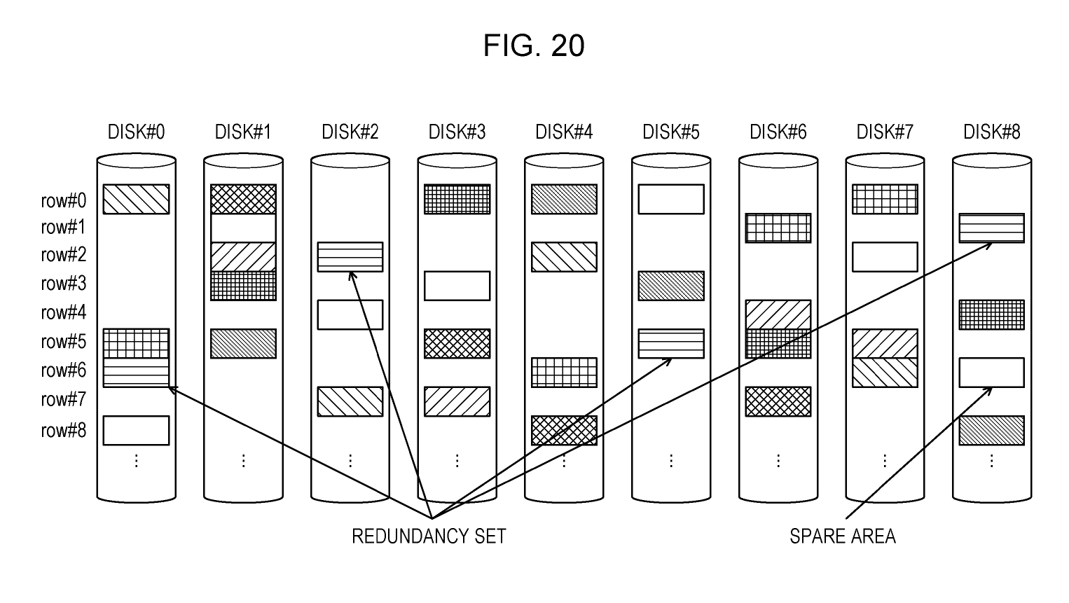

For example, the following two methods can be considered as the distributed disposition of the FR-Unit and the FHS. A first method is a method of disposing all FR-Depths included in the same FR-Unit in the same FR-Band. A second method is a method of disposing FR-Depths included in the same FR-Unit in different FR-Bands, and managing the disposed storages and data positions on the storages. A disk pool configuration by the first method is illustrated in FIG. 19, and a disk pool configuration by the second method is illustrated in FIG. 20.

In the first method, as a disposition destination of each FR-Depth included in the same FR-Unit, only disk numbers in each row may be managed and positions on each disk may not be managed. Even during the Rebuild process, data on a failed disk may be recovered to a FHS in the same row on another disk. Therefore, it is possible to reduce a table capacity for distributed layout management. However, in the first method, since the disposition destination of each FR-Depth included in the same FR-Unit is the same row, addition to a disk pool is units of the number of FR-Depths included in the FR-Unit and it lacks flexibility.

In the second method, the addition to the disk pool can be performed in units of one. However, in the second method, disk numbers and positions on the disks are managed as disposition destinations of FR-Depths included in the same FR-Unit. Thus, a table capacity for distributed layout management increases. Therefore, a restriction such as increasing a size of the redundancy set or reducing a capacity of a management target occurs. In the second method, it is complicated to determine a data recovery destination of the failed disk during the Rebuild process and change a distributed layout at the time of the disk addition to the disk pool. This is because all FR-Depths in respective FR-Units become different disks after Rebuild process completion or after the distributed layout change. Therefore, a management technique such as selecting the most appropriate pattern from several predetermined distributed patterns is desirable.

In a case of forming the predetermined or a uniform distributed pattern or in a case of changing the distributed layout due to the disk addition or the like, both of the first method and the second method replace existing data. In the case, it has a temporary work buffer area for the data replacement, and extra reading and writing in the buffer area occurs during the data replacement.

In the present embodiment, respective data included in FR-Unit are disposed on different storages of the plurality of storages, and in different FR-Bands within a divided physical address range divided by the same size of the FR-Unit. Hereinafter, the divided physical address range divided by the same size of the FR-Unit is referred to as “FR-WideBand”. The number of rows included in the FR-WideBand matches the number of FR-Depths included in FR-Unit. As a result, it is possible to perform the addition to the disk pool in units of one.

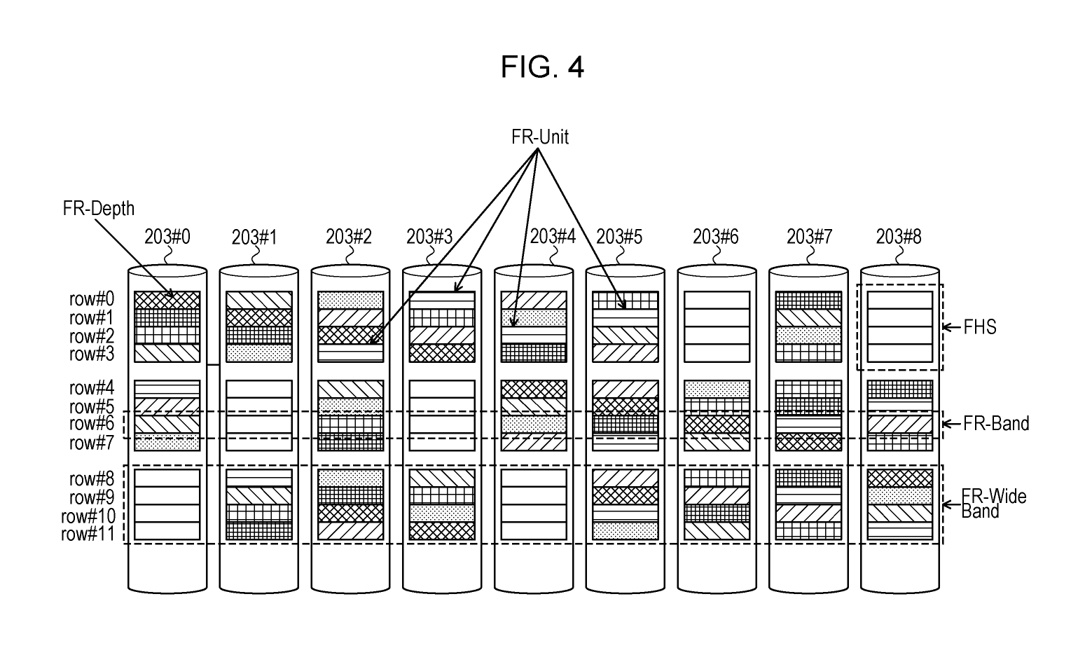

In the present embodiment, the FHSs are disposed in continuous address areas of the same storage capacity as one FR-Unit on any storage of each FR-WideBand. The position in the storage for each component of the redundancy set may not be managed due to the disposition of the FR-Unit and the FHS described above, and the table capacity for distributed layout management can be reduced. The disk pool configuration according to the present embodiment is illustrated in FIG. 4.

In the present embodiment, when a new storage is added to the disk pool configuration, data having different addresses are transferred from the redundancy set corresponding to the number of divisions in the FR-WideBand to the new storage. As a result, since the data replacement does not occur, a data transfer during the disk pool configuration change can be minimized.

An operation example of a Rebalance process of the storage control apparatus 101 will be described with reference to FIG. 1. Here, the Rebalance process is a process for improving a degree of distribution of a data disposition in the Fast Recovery RAID. The storage control apparatus 101 can access storages 102#0 to #8 as the plurality of storages. In the following description, in a case of distinguishing the same type of components, reference numerals such as “storage 102#0” and “storage 102#1” may be used, and in a case of not distinguishing the same type of components, only a common number of the reference numeral such as “storage 102” may be used.

In FIG. 1, respective data included in the FR-Unit are disposed on different storages of storages 102#0 to #8, and in different FR-Bands in the FR-WideBand. Here, any of void, hatching, and fill is assigned to the respective data of the disk pool configuration illustrated in the following drawings including FIG. 1, and the same hatched or filled dataset is one redundancy set. A void part is the FHS.

In the state of FIG. 1, one FR-Unit is formed with four FR-Depths as the number of divisions, and there is one FHS. One FR-WideBand is formed with rows #0 to #3.

In the state of FIG. 1, the storage control apparatus 101 determines to perform a distributed layout change of respective data with a new storage or a storage to be the FHS as a data transfer target storage. For example, when an instruction to add a new storage is accepted, the storage control apparatus 101 determines to perform the distributed layout change of respective data with the new storage as the data transfer target storage. When performing data transfer to the FHS, the storage control apparatus 101 may determine to perform the distributed layout change of respective data with the FHS as the data transfer target storage. For example, the case of transferring the data to the FHS is a case where the storage control apparatus 101 accepts an instruction to transfer the data also to the FHS to any of a plurality of FHSs from a user of the storage control apparatus 101 in a case where the plurality of FHSs exist.

As illustrated by (1) of FIG. 1, since the storage control apparatus 101 accepts the instruction to add a storage 102#9 as the new storage, the storage control apparatus 101 determines to perform the distributed layout change of respective data with the storage 102#9 as the data transfer target storage.

In a case of determining to perform the distributed layout change of respective data, as illustrated by (2) of FIG. 1, the storage control apparatus 101 selects data disposed in the FR-WideBand and data disposed in different the FR-Bands corresponding to each FR-Unit of the FR-Unit of the number of divisions.

For example, in the example of FIG. 1, the storage control apparatus 101 selects data of a storage 102#5 belonging to FR-Unit to which hatching of large grid patterns is assigned for row#0. The storage control apparatus 101 selects data of a storage 102#7 belonging to FR-Unit to which hatching of oblique lines from upper right to lower left is assigned for row#1. The storage control apparatus 101 selects data of a storage 102#2 belonging to FR-Unit to which hatching of oblique grid patterns is assigned for row#2. The storage control apparatus 101 selects data of a storage 102#4 belonging to FR-Unit to which hatching of small grid patterns is assigned for row#3.

As illustrated by (3) of FIG. 1, the storage control apparatus 101 transfers data selected corresponding to each FR-Unit to the same row on the storage 102#9 as a row in which the data is disposed.

As a result, since the storage control apparatus 101 distributes the data without replacing existing data, the data transfer during the disk pool configuration change can be minimized. The RAID level of the redundancy set according to the present embodiment is not limited particularly. The method illustrated in FIG. 1 can be employed also at the time of copyback. The copyback means that data of a failed storage or a storage to be reduced is recovered or copied to the FHS by the Rebuild process, and then the FHS data is copied to a storage substituting for the failed storage or a storage to be reduced.

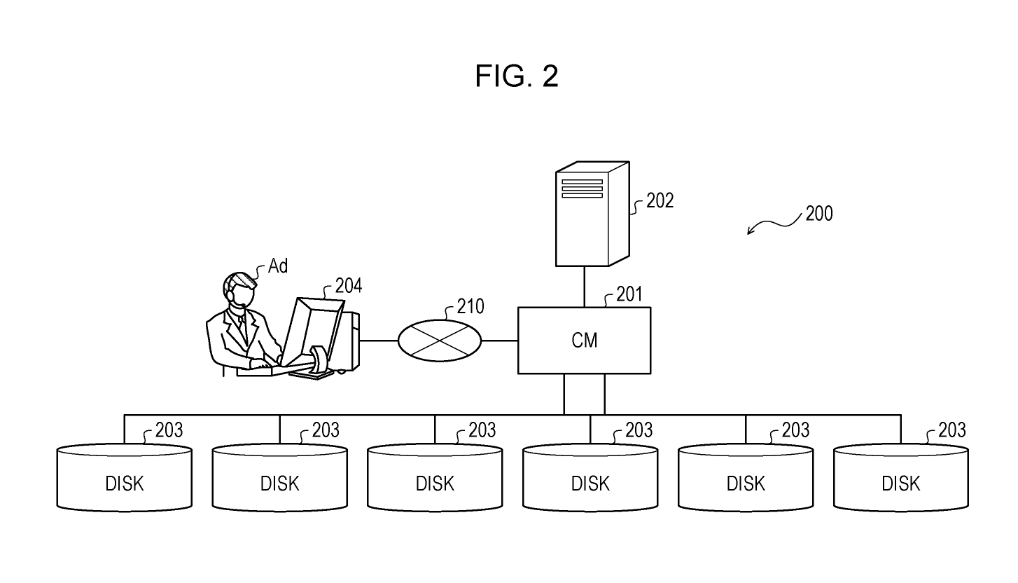

The method illustrated in FIG. 1 can be employed also in the Rebuild process. For example, it is assumed that the storage control apparatus 101 detects a failed storage among the plurality of storages or accepts an instruction to remove a reduction target storage from the plurality of storages. At the time, the storage control apparatus 101 determines to perform the distributed layout change of respective data with the FHS as the data transfer target storage. In a case of determining to perform the distributed layout change of respective data, the storage control apparatus 101 selects respective data of the failed storage or the reduction target storage corresponding to each FR-Unit of the FR-Unit of the number of divisions. Here, the respective data of the failed storage or the reduction target storage are data disposed in FR-WideBand and data disposed in different FR-Bands. Then, the storage control apparatus 101 transfers the data selected corresponding to each FR-Unit to the same row on the FHS to be the data transfer target storage and as a row in which the data is disposed. Here, as a data transfer method, since data may not be acquired from the failed storage, the storage control apparatus 101 recovers the selected data from data other than the data selected by each FR-Unit and writes the recovered data in the FHS. Since data can be acquired from the reduction target storage, the storage control apparatus 101 acquires the selected data from the reduction target storage and writes the acquired data to the FHS. Next, an example in which the storage control apparatus 101 is employed in a storage system will be described with reference to FIG. 2.

FIG. 2 is an explanatory diagram illustrating a configuration example of a storage system 200. The storage system 200 includes a controller module (CM) 201, a host apparatus 202, a plurality of disks 203, and an administrator terminal 204. The CM 201 and the administrator terminal 204 are connected to each other through a network 210 such as the Internet, a local area network (LAN), a wide area network (WAN). The CM 201 corresponds to the storage control apparatus 101 illustrated in FIG. 1. The disk 203 corresponds to the storage 102 illustrated in FIG. 1.

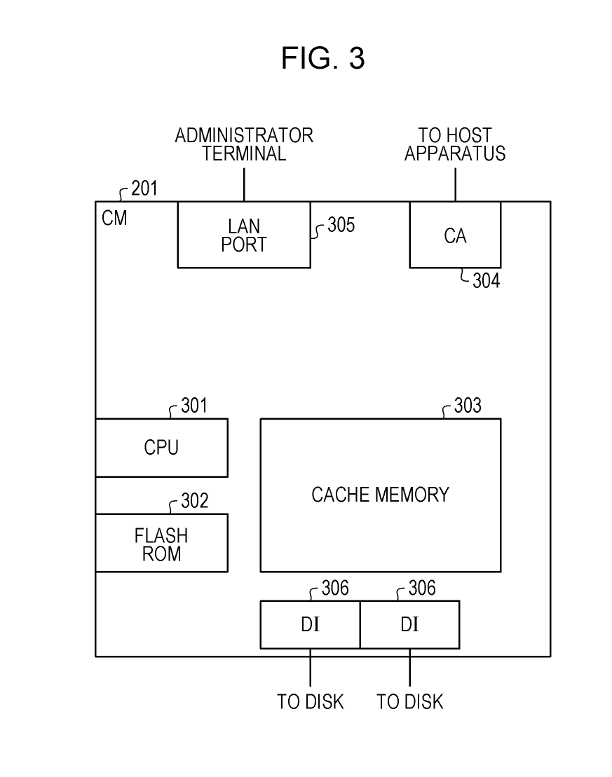

The CM 201 is a controller that controls disk access. As illustrated in the example of FIG. 2, the CM 201 may have the plurality number of CMs 201, and the CM 201 may have a redundancy configuration. Internal hardware of the CM 201 will be described in FIG. 3. The host apparatus 202 is an apparatus that uses a volume provided by the storage system 200. For example, the host apparatus 202 is a web server or a database (DB) server.

The disk 203 is a storage apparatus having a storage area provided by the storage system 200. For example, the disk 203 can employ a hard disk drive (HDD) or solid state drive (SSD).

The administrator terminal 204 is a computer operated by an administrator Ad who manages the storage system 200. Next, a hardware configuration example of the CM 201 will be described with reference to FIG. 3.

FIG. 3 is an explanatory diagram illustrating a hardware configuration example of a CM 201. The CM 201 includes a central processing unit (CPU) 301, a flash read only memory (ROM) 302, a cache memory 303, a channel adaptor (CA) 304, a LAN port 305, and a disk interface (DI) 306.

The CPU 301 is an arithmetic process apparatus that controls the entire CM 201. The flash ROM 302 is a non-volatile memory that stores the storage control program according to the present embodiment. As a storage medium of the flash ROM 302, for example, a NAND flash memory can be employed. The cache memory 303 is a volatile memory used as a work area of the CPU 301. The cache memory 303 stores the storage control program read from the flash ROM 302.

The CA 304 is a communication interface that communicates with the host apparatus 202. The LAN port 305 is a communication interface connected to the administrator terminal 204. The DI 306 is a communication interface that communicates with the disk 203.

The host apparatus 202 includes a CPU, a flash ROM, a cache memory, and a communication interface. The administrator terminal 204 includes a CPU, a flash ROM, a cache memory, a communication interface, a display, a keyboard, and a mouse. Next, a disk pool configuration example according to the present embodiment will be described with reference to FIG. 4.

FIG. 4 is an explanatory diagram illustrating the disk pool configuration example according to the present embodiment. In FIG. 4, as the disk pool configuration according to the present embodiment is the disk pool configuration in which configuration components of a redundancy set are located at different positions of respective disks and the positions for respective data in the redundancy set may not be managed. A disposition pattern of the FR-Unit is generated at the time of the disk pool configuration change such as disk pool creation and failure, replacement, addition, and deletion of the disk 203. When an event that triggers the disk pool configuration change occurs, the CM 201 heuristically creates and evaluates FR-Unit patterns that satisfy the following eight conditions to generate the FR-Unit patterns.

A first condition: It is desirable that all FR-Depths that form one FHS are disposed on the same disk.

A second condition: A disk is selected such that the FHS is as uniform as possible among disks.

A third condition: A disk is selected such as the FHS is as uniform as possible among patterns for each disk.

A fourth condition: A plurality of FR-Depths belonging to the same FR-Unit may not be disposed on the same disk.

A fifth condition: All FR-Depths belonging to the same FR-Unit exist in the same FR-WideBand.

A sixth condition: Another disk is selected such that another disk belonging to the same FR-Unit is as uniform as possible among disks for each disk.

A seventh condition: Another disk is selected such that another disk belonging to the same FR-Unit is as uniform as possible among patterns for each disk.

An eighth condition: In a case of changing an existing distributed layout, a change such that a FR-Depth in which data is stored already is replaced with another FR-Depth is not performed.

With the eighth condition described above, the CM 201 performs a data transfer targeting only an additional disk or an unused FHS area by suppressing data replacement at the time of the layout change. As a result, the CM 201 can perform the layout change in a state of maintaining the redundancy, and can avoid extra read/write through a work buffer.

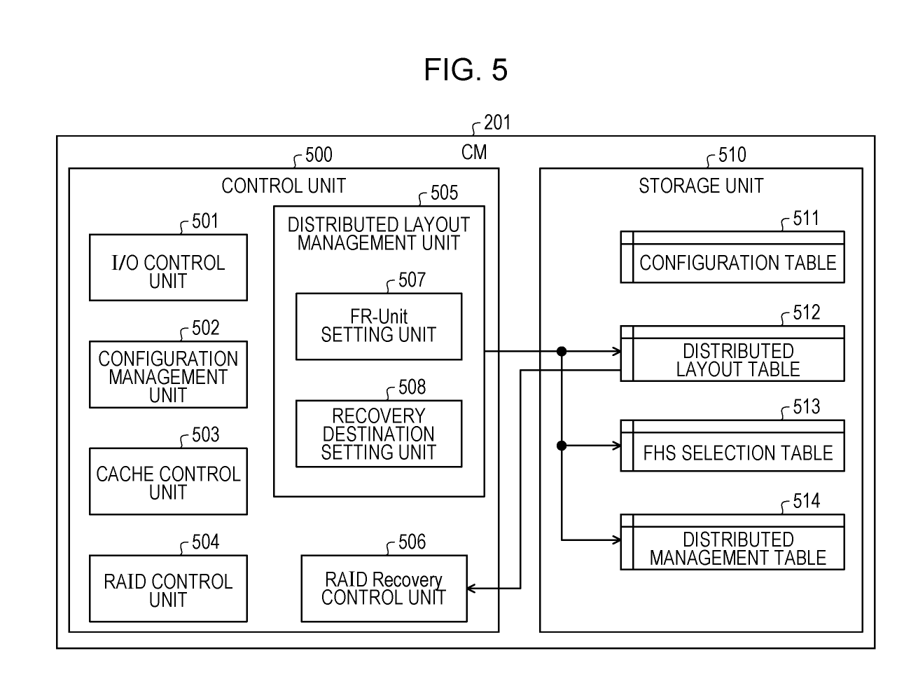

FIG. 5 is an explanatory diagram illustrating a function configuration example of the CM 201. The CM 201 includes a control unit 500. The control unit 500 includes an I/O control unit 501, a configuration management unit 502, a cache control unit 503, a RAID control unit 504, a distributed layout management unit 505, and RAID Recovery control unit 506. The distributed layout management unit 505 includes a FR-Unit setting unit 507, a recovery destination setting unit 508. The control unit 500 realizes a function of each unit by causing the CPU 301 to execute the program stored in the storage apparatus. Specifically, the storage apparatus is, for example, the flash ROM 302 and the cache memory 303 illustrated in FIG. 3. A process result of each unit is stored in the cache memory 303, a register of the CPU 301, and the like.

The storage control apparatus 101 can access a storage unit 510. The storage unit 510 is stored in the storage apparatus such as the cache memory 303. The storage unit 510 includes a table area that stores a configuration table 511, a distributed layout table 512, a FHS selection table 513, and a distributed management table 514.

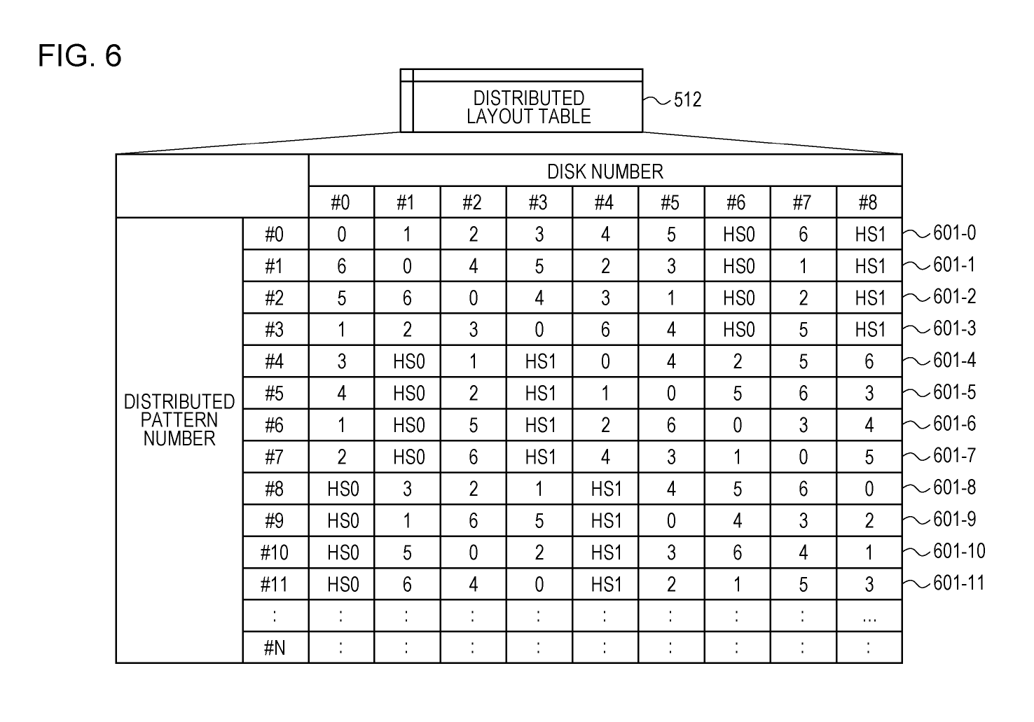

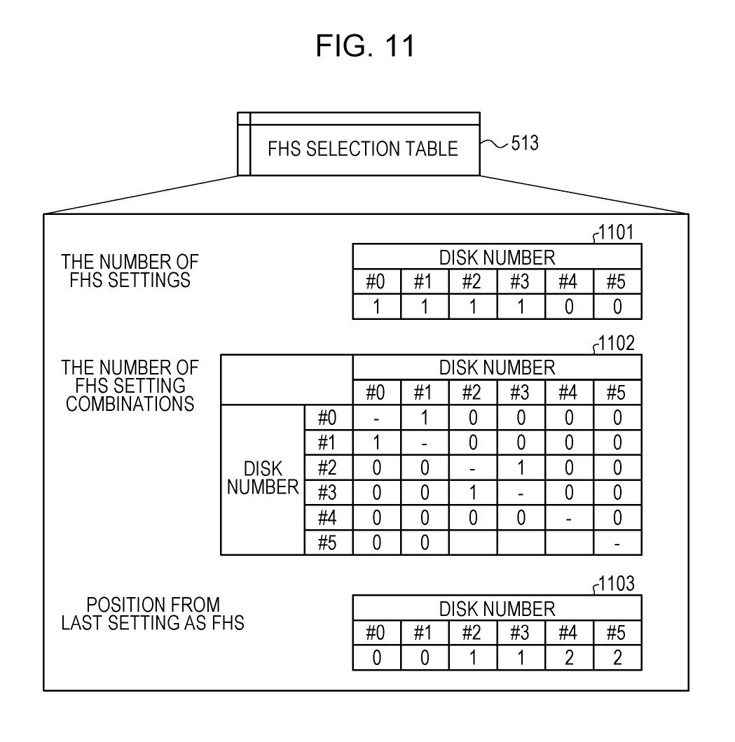

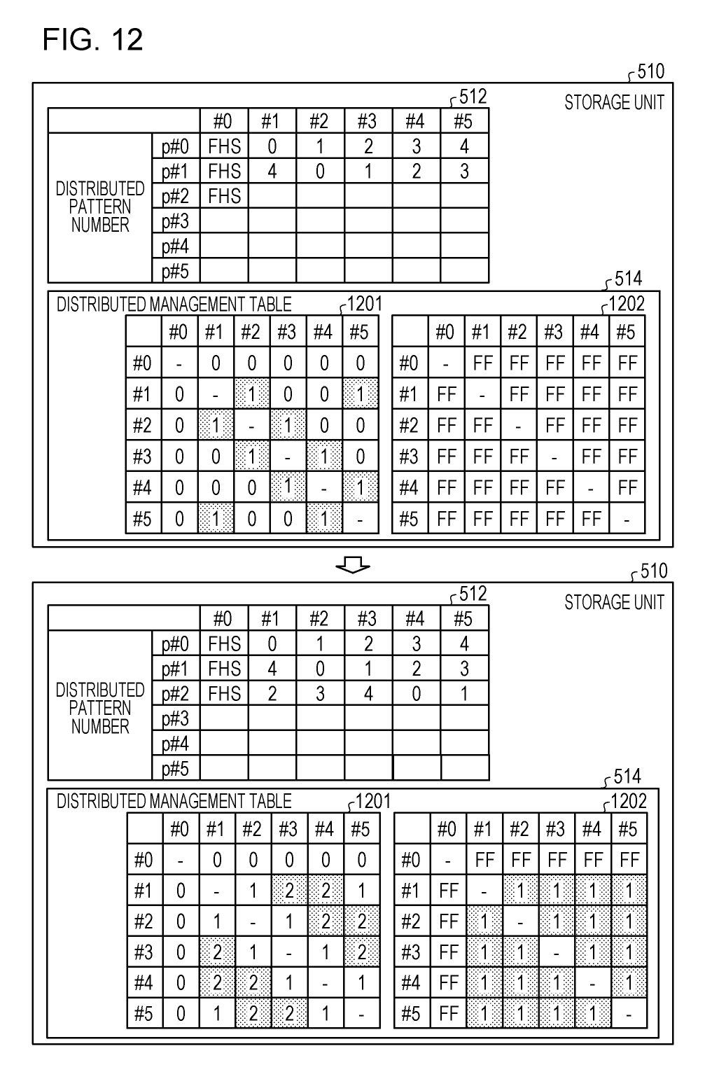

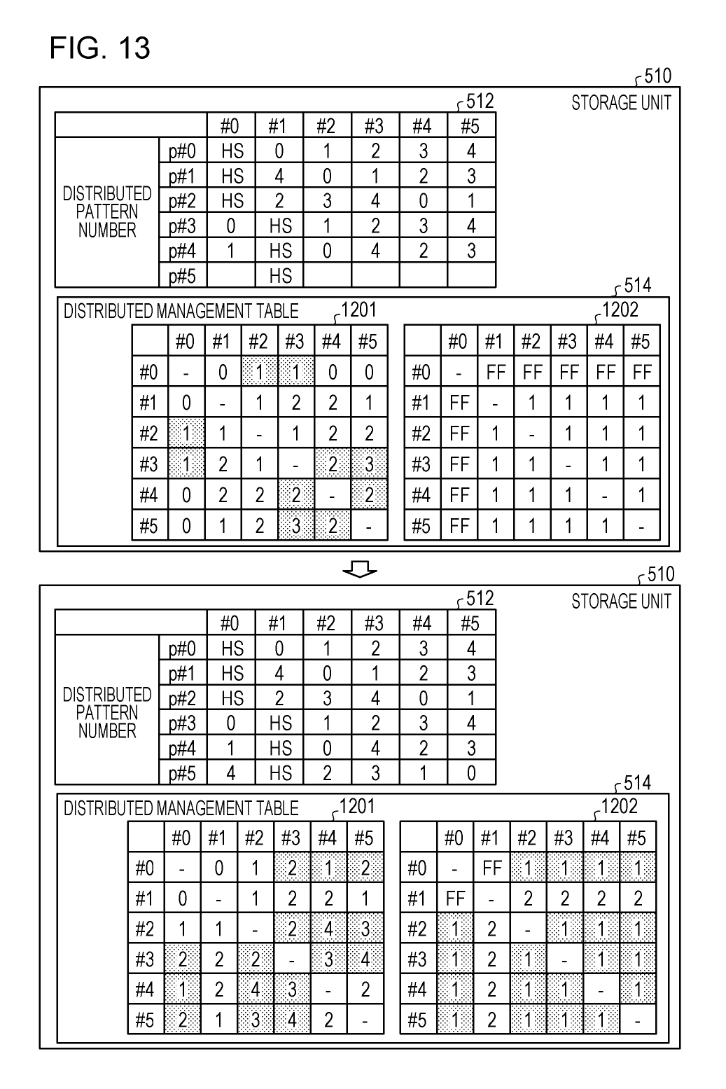

The configuration table 511 is a table that has information indicating an internal configuration of the apparatus such as the RAID configuration, a volume configuration, and mapping. The distributed layout table 512 is a table used for converting a logic address as a RAID, and a disk number and an address on each disk. An example of storage contents of the distributed layout table 512 is illustrated in FIG. 6. The FHS selection table 513 and the distributed management table 514 are tables that store information during execution of the Rebuild process and the Rebalance process. An example of storage contents of the FHS selection table 513 is illustrated in FIG. 11. An example of storage contents of the distributed management table 514 is illustrated in FIGS. 12 and 13.

The I/O control unit 501 executes an I/O request and response from the host apparatus 202.

The configuration management unit 502 manages the internal configuration of the apparatus such as the RAID configuration, the volume configuration, and the mapping, and stores information used for the management in the configuration table 511.

The cache control unit 503 manages a disposition of accepted I/O data on the cache memory 303, staging from the disk 203, and a timing of writeback to the disk 203.

The RAID control unit 504 cooperates with the distributed layout management unit 505 to issue a command to each disk 203, and manages a load of the RAID.

The distributed layout management unit 505 generates and changes a data distribution layout inside the Fast Recovery RAID. Information managed by the distributed layout management unit 505 is stored in the distributed layout table 512.

The RAID Recovery control unit 506 schedules the Rebuild process due to the disk failure and the Rebalance process due to the disk replacement and addition, and manages progress.

The FR-Unit setting unit 507 performs data distribution of FR-Unit when the disk 203 is added and when there is an instruction to transfer data to an unused FHS area. For example, it is assumed that the I/O control unit 501 accepts an instruction to add a new disk 203. In the case, the FR-Unit setting unit 507 selects data disposed in FR-WideBand and data disposed in different FR-Bands corresponding to each FR-Unit of the FR-Unit of the number of divisions. Then, the FR-Unit setting unit 507 determines so as to transfer the data selected corresponding to each FR-Unit to the same row on new disk 203 as a row in which the data is disposed. The FR-Unit setting unit 507 stores information on a transfer destination in the distributed layout table 512.

The FR-Unit setting unit 507 may select data based on the number of combinations between a disk 203 in which data is disposed and disks 203 in which each FR-Unit disposed in the plurality of disks 203 is disposed.

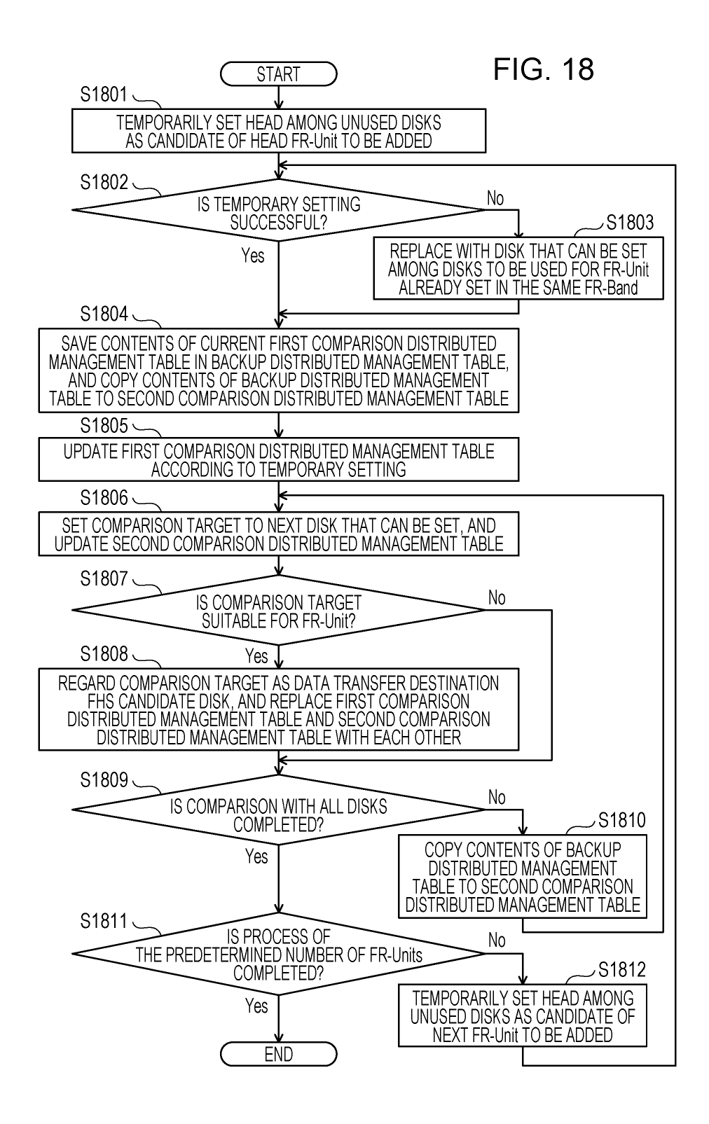

For example, assuming that data of each disk 203 is transferred, the FR-Unit setting unit 507 may obtain the number of combinations between a disk 203 in which the data after the assumption is disposed and the disks 203 in which respective FR-Units disposed in the plurality of disks 203 are disposed. The FR-Unit setting unit 507 obtains the number of combinations between the disks 203 after the assumption with respect to each piece of data of each disk 203, and selects data assumed to be transferred when the number of combinations between the disks 203 after the assumption becomes the smallest. A more specific method will be described in a process of step S1807 of FIG. 18.

A matter indicated by the number of combinations between the disks 203 will be described with reference to the following example. For example, it is assumed that there are disks 203#0 to #3, three FR-Units including two data, and one FHS. The three FR-Units are assumed as FR-Units #A, #B, and #C, respectively. Since the FR-Unit includes two data, two rows are included in one FR-WideBand. The FR-Unit and the FHS are assumed to be disposed in the order of the disks 203#0, #1, #2, and #3 as described below. In the following example, the FR-Unit#A, the FR-Unit#B, and the FR-Unit#C are described simply as “#A”, “#B”, and “#C”. The FHS is described simply as “HS”.

row#0: #A, #B, #C, and HS

row#1: #B, #C, #A, and HS

row#2: #C, #A, HS, and #B

row#3: #B, #C, HS, and #A

In the case, the combination between disks 203 in which the FR-Unit#A is disposed is disks 203#0 and #2, disks 203#1 and #3. The combination between disks 203 in which the FR-Unit#B is disposed is disks 203#0 and #1, disks 203#0 and #3. The combination between disks 203 in which the FR-Unit#C is disposed is disks 203#1 and #2, disks 203#0 and #1. Accordingly, with respect to the number of combinations between the disks 203, the combination of the disks 203#0 and #1 is twice, the combination of the disks 203#2 and #3 is once, and other combinations are once. Here, in a case where any of the disks 203#0 and #1 in which the combination is twice fails, compared with a case where the disks 203#2 and #3 fails, there is a disk 203 in which the reading is concentrated as compared with other disks 203.

For example, in a case where the disk 203#0 fails, in order to recover rows #0 to #3 of the disk 203#0, the row#1 of the disk 203#2, the row#0 of the disk 203#1, the row#3 of the disk 203#1, and the row#2 of the disk 203#3 are read. Accordingly, in the case where the disk 203#0 fails, two reading requests are issued to the disk 203#1. On the other hand, in a case where the disk 203#2 fails, in order to recover rows #0 and #1 of the disk 203#2, the row#1 of the disk 203#1, and the row#0 of the disk 203#0 are read. As described above, in the case where the disk 203#2 fails, only one reading request is issued to the disk 203 and two reading requests do not occur. Accordingly, it can be said that the number of combinations between the disks 203 indicates the number of readings to other disks 203 when one disk 203 fails during the Rebuild process.

In the example described above, the FR-Unit setting unit 507 may select data of FR-Units which have the combination of the disks 203#0 and #1 among the disks 203#0 and #1 having the largest number of combinations. For example, the FR-Unit setting unit 507 selects data of the FR-Unit#C disposed in the row#2 of the disk 203#0. In the example described above, the data of the row#2 of the disk 203#0 is transferred and the reading to the disk 203#1 is decreased by once. Therefore, since there is no disk 203 in which the reading is concentrated, it is possible to reduce a time taken for the Rebuild process.

The recovery destination setting unit 508 sets the recovery destination of data when performing the Rebuild process. Specifically, it is assumed that the configuration management unit 502 detects a failed disk 203 among the plurality of disks 203 or the I/O control unit 501 accepts an instruction to remove the reduction target disk from the plurality of disks 203. In the case, the recovery destination setting unit 508 sets data in which the failed disk 203 or the reduction target disk 203 stores so as to be recovered to a FR-Depth on a FHS and the same row as the data based on a FR-Unit including the data.

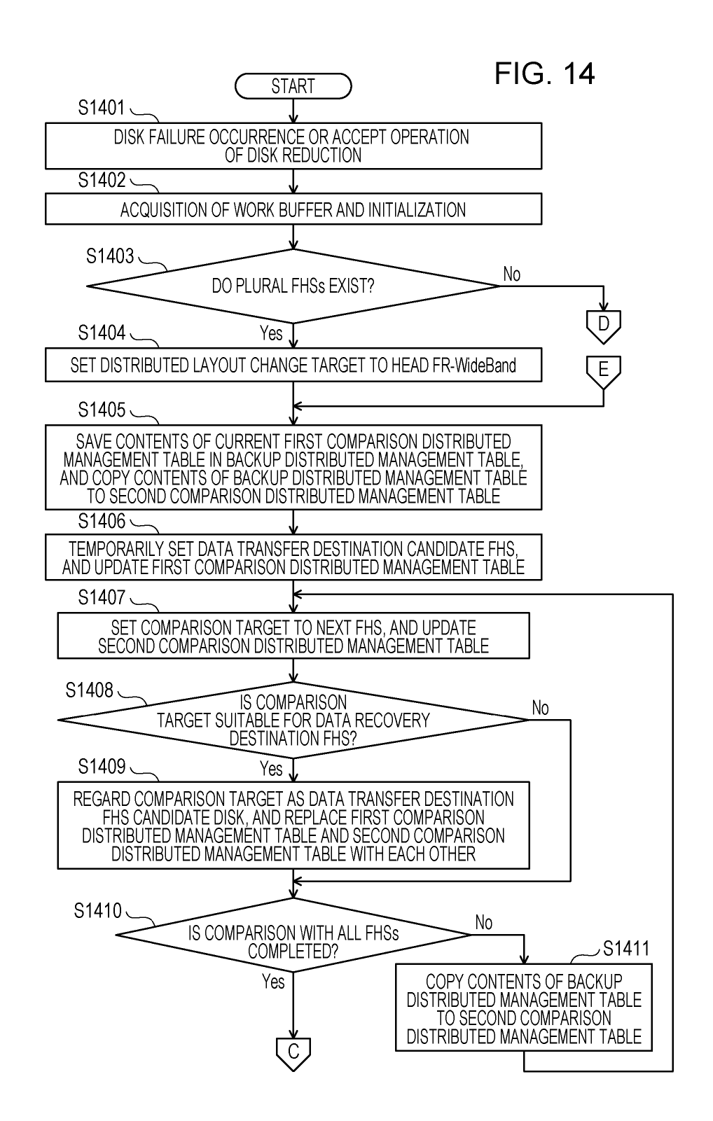

There may be two or more FHSs. In the case, the recovery destination setting unit 508 may count the number of combinations between disks 203 in which each FR-Unit disposed in the plurality of disks 203 in a state after recovering data in each FHS of the two or more FHSs is disposed corresponding to the two or more FHSs. The recovery destination setting unit 508 determines a recovery destination FHS from the two or more FHSs based on the counted number of combinations corresponding to each of the two or more FHSs. The number of combinations between disks 203 is obtained by the same method as the FR-Unit setting unit 507. For example, the recovery destination setting unit 508 determines a FHS having many smaller values from the counted number of combinations corresponding to each FHS of the two or more FHSs as the recovery destination FHS. A more specific method will be described in a process of step S1408 of FIG. 14.

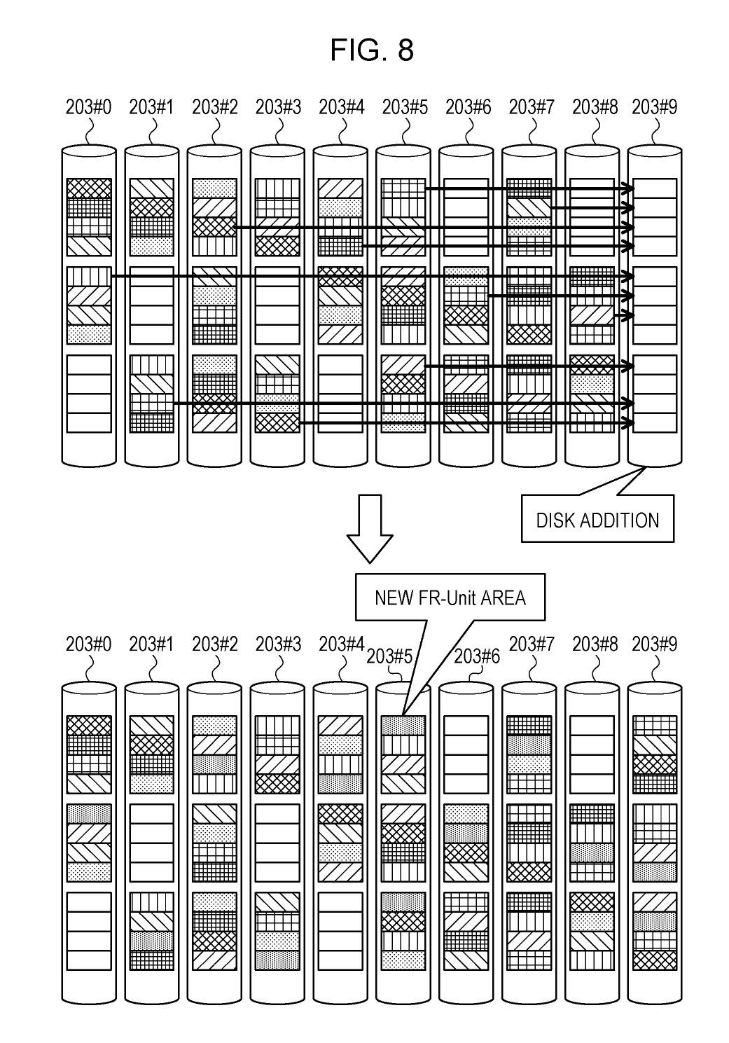

FIG. 6 is an explanatory diagram illustrating an example of storage contents of the distributed layout table 512. The distributed layout table 512 illustrated in FIG. 8 includes records 601-1 to 11.

The distributed layout table 512 is a two-dimensional array of disk numbers in Fast Recovery RAID and distributed pattern numbers generated according to the rules illustrated in FIG. 4. The distributed layout table 512 illustrated in FIG. 6 indicates an example of a case where there are nine disks 203, four redundancy members, and two FHSs. Each member of the distributed layout table 512 stores the FR-Unit number in the FR-WideBand.

It is assumed that the logic address as the RAID is assigned in an address direction of the disk. Hereinafter, the logic address as the RAID is referred to as “RAID logical block addressing (RLBA)”. Specifically, the RLBA is in the following order.

The FR-WideBand#0 FR-Unit#0 FR-WideBand#1 FR-Unit#0→. . . →FR-WideBand#N FR-Unit#0→FR-WideBand#0 FR-Unit#1→FR-WideBand#1 FR-Unit#1→. . . →FR-WideBand#N FR-Unit#1→. . . →FR-WideBand#0 FR-Unit#M→FR-WideBand#1 FR-Unit#M→. . . →FR-WideBand#N FR-Unit#M.

In a case where a disk is added to the Fast Recovery RAID, the CM 201 (illustrated in FIG. 5) can append an area at the end without changing the RLBA in use by employing such addressing. The CM 201 performs the following process in order to convert the RLBA to a physical position on the disk.

The CM 201 specifies a corresponding FR-WideBand number and a FR-Unit number in the FR-WideBand from a quotient obtained by dividing the RLBA by a FR-Unit size and the number of FR-WideBands existing on one disk. Next, the CM 201 specifies a FR-Depth number in the FR-Unit from a quotient obtained by dividing a remainder obtained by dividing the RLBA by the FR-Unit size by a FR-Depth size. The CM 201 specifies a corresponding disk number and address on the disk with reference to a part corresponding to the obtained FR-WideBand number, FR-Unit number, and FR-Depth number from the distributed layout table 512. The CM 201 may store the distributed layout table 512 so as to be unique through the disk 203, or may periodically store the disk 203 divided into a certain size.

In a case where the distributed layout table 512 is displayed in the drawing after FIG. 6, the description of “disk number” may be omitted from the convenience of display.

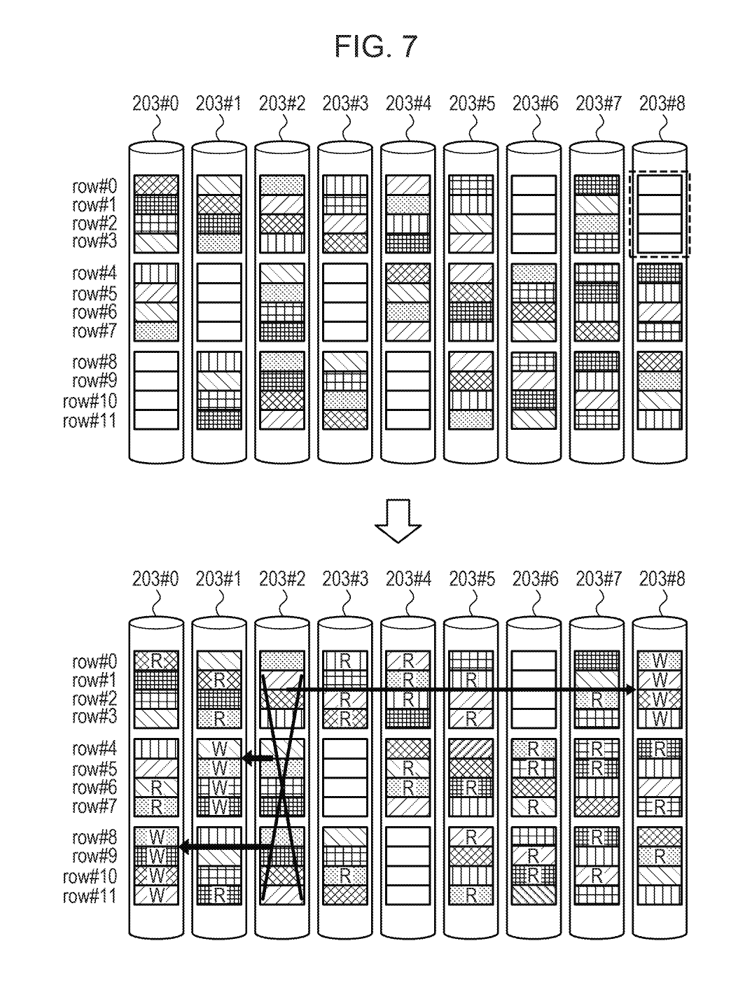

FIG. 7 is an explanatory diagram illustrating an operation example of the Rebuild process. In the case where the disk failure occurs, the CM 201(illustrated in FIG. 5) recovers data on a failed disk to a FHS on the same FR-WideBand. First, the CM 201 creates a distributed layout table 512 after configuration change. In a case where the plurality of FHSs exist on each FR-WideBand, a FHS is selected so as to satisfy the generation requirements of the distributed pattern described above as much as possible.

A Rebuild schedule is performed by the RAID Recovery control unit 506 of a controller of the storage apparatus. The RAID Recovery control unit 506 prepares two bits for management information indicating whether the Rebuild is performed or not for each FR-Band of a target RAID, and manages the bitmap. Here, a reason why the management information has a data size of two bits is to continue the process even in a case where three or more states such as the disk failure during another configuration change are mixed.

FIG. 7 illustrates an operation example of the Rebuild process. The disk configuration illustrated in FIG. 7 is an example of nine-disk configuration Fast Recovery RAID including two FHS areas, and forming one FR-WideBand by four FR-Bands. In the case where the disk failure occurs, the RAID Recovery control unit 506 recovers the data on the failed disk to the FHS area on the same FR-WideBand. The CM 201 realizes a recovery speed equal to or higher than throughput of the disk alone by distributing the disk reading between the FR-Bands and the disk writing between the FR-WideBands. Specifically, the disk reading between the FR-Bands is distributed by the sixth condition and the seventh condition of the disposition pattern of the FR-Unit. The disk writing between the FR-WideBands is distributed by the second condition and the third condition of the disposition pattern of the FR-Unit.

The operation example of the Rebuild process will be described more specifically with reference to FIGS. 5 and 7. A disk configuration illustrated in the upper part of FIG. 7 is a disk pool configuration before a failure occurs. The disk pool configuration illustrated in FIG. 7 is formed by disks 203#0 to #8 since it has nine-disk configuration. It is assumed that a disk 203#2 fails. A disk configuration illustrated in the lower part of FIG. 7 is a disk pool configuration after the disk 203#2 fails and the Rebuild process is completed. The RAID Recovery control unit 506 recovers data of the disk 203#2 to FHS areas of rows #0 to #3 of the disk 203#8, rows #4 to #7 of the disk 203#1, and rows #8 to #11 of the disk 203#0 as illustrated by filled arrows.

Among respective data illustrated in the lower part of FIG. 7, data in which “R” is written is data in which the reading occurs during the Rebuild process, while data in which “W” is written is data in which the writing occurs during the Rebuild process. As illustrated by distribution of the data in which “R” is written illustrated in the lower part of FIG. 7, it can be seen that the disk reading between FR-Bands is distributed. As illustrated by distribution of the data in which “W” is written illustrated in the lower part of FIG. 7, it can be seen that the disk writing between FR-WideBands is distributed.

FIG. 8 is an explanatory diagram illustrating an operation example of the Rebalance process. In the present embodiment, in a case where the replacement or the addition of the failed disk is performed, data is transferred on the same FR-Band to perform the Rebalance of the distribution. First, with respect to FIG. 5, the distributed layout management unit 505 creates a distributed layout table 512 after the disk pool configuration change according to the generation requirements of the distributed pattern described above. At the time, re-disposition can be executed in a state of maintaining the redundancy by selecting only a FR-Depth in which data is not stored, such as an area on the added disk or an unused FHS area, as a data transfer destination. Here, even in a case where a failed disk belonging to a disk group is replaced, the same distributed pattern before the failure may not be obtained.

FIG. 8 illustrates an operation example of the Rebalance process when a disk is added and a user capacity increases. The disk pool configuration illustrated in FIG. 8 is an example of nine-disk configuration disk group including two FHS areas, and forming one FR-WideBand by four FR-Bands. In a case of executing the disk addition, data on each FR-Band is redistributed with the added disk in the same FR-Band or the unused FHS area as the transfer destination according to demand. When the data transfer is completed, the capacity of the added FR-Unit can be used.

The Rebalance process will be described more specifically with reference to FIGS. 5 and 8. The disk pool configuration illustrated in FIG. 8 is formed by the disks 203#0 to #8 since it has the nine-disk configuration. It is assumed that a disk 203#9 is added to the disk pool configuration illustrated in FIG. 8 as illustrated in the upper part of FIG. 8. The RAID Recovery control unit 506 executes the Rebalance process according to a distributed layout table 512 after the disk pool configuration change. As illustrated by arrows of the upper part of FIG. 8, the RAID Recovery control unit 506 sets only a FR-Depth in which data is not stored, such as an area on the added disk or an unused FHS area, as a data transfer destination.

The lower part of FIG. 8 illustrates an example in which a new FR-Unit area is set as a redundancy set to which hatching of polka-dot pattern by a large circle is assigned after completion of the Rebalance process.

Next, a disk pool creation process performed by the CM 201 will be described with reference to FIGS. 5, 9 and 10.

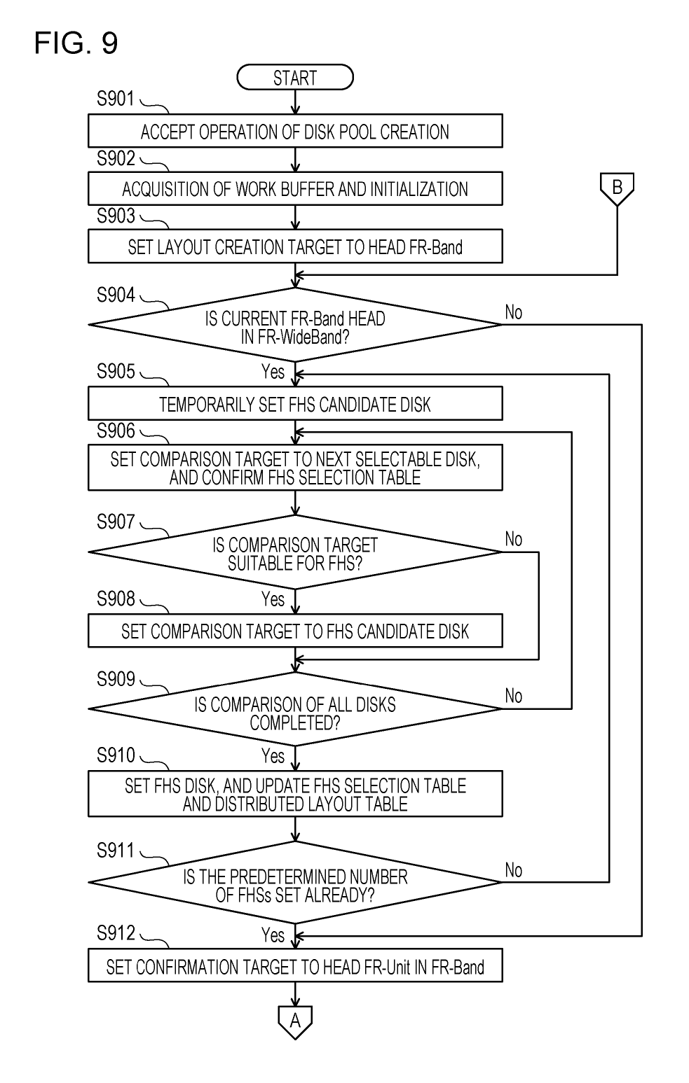

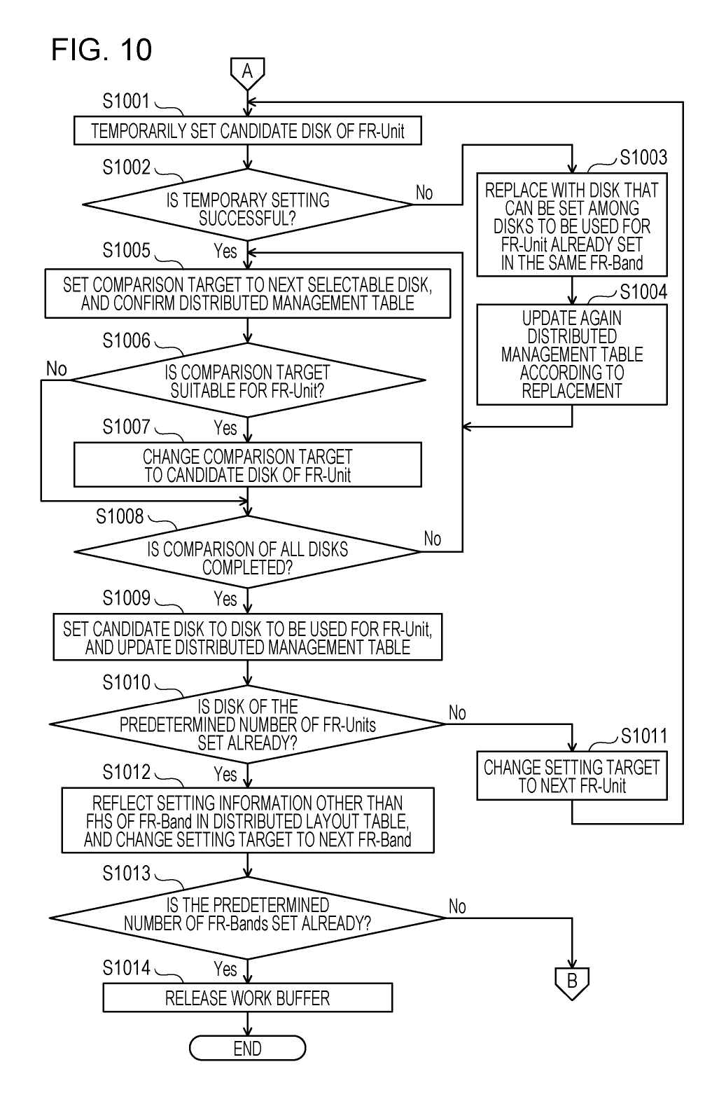

FIG. 9 is a flowchart (part 1) illustrating an example of a disk pool creation process procedure. FIG. 10 is a flowchart (part 2) illustrating an example of the disk pool creation process procedure. The CM 201 accepts an operation of disk pool creation from the administrator terminal 204 (step S901). At that time, the administrator terminal 204 displays input items by management graphical user interface (GUI) on the display of the administrator terminal 204. The input items are items for inputting, for example, the number of disks to be used for disk pool, the number of disks corresponding to a capacity to be used as a spare area, the number of FR-Depths included in a FR-Unit, and a RAID level of the FR-Unit. In the administrator terminal 204, all the input items may be input by the administrator Ad or specified values may be set in advance in the input items.

Next, the distributed layout management unit 505 acquires the work buffer used for distributed layout creation on the cache memory 303, and creates and initializes the FHS selection table 513 and the distributed management table 514 (step S902). In the following processes, the distributed layout management unit 505 controls the flow until the end of the disk pool creation process.

Then, the distributed layout management unit 505 sets a layout creation target to the head FR-Band (step S903). Next, the distributed layout management unit 505 determines whether current FR-Band is the head in FR-WideBand (step S904). In a case where the current FR-Band is the head in FR-WideBand (Yes in step S904), the distributed layout management unit 505 temporarily sets a FHS candidate disk in the current FR-WideBand from unused disks (step S905). Next, the distributed layout management unit 505 sets a comparison target to a next selectable disk and confirms the FHS selection table 513 (step S906). Then, the distributed layout management unit 505 determines whether the comparison target is a disk which is more suitable for FHS than the FHS candidate disk (step S907). Here, the distributed layout management unit 505 determines whether the disk is suitable for FHS by priority in the order of the following three conditions.

A first condition: The number of times set as FHS through distributed layout is small.

A second condition: In a case where a plurality of FHSs exist, the number of combinations with another FHS in the same FR-WideBand is small.

A third condition: A position from the last setting as a FHS in the previous FR-WideBand to current FR-WideBand is far.

For example, when the set number of times of the FHS between the FHS candidate disk and the comparison target is the same in the first condition, the distributed layout management unit 505 determines using the second condition. In the three conditions described above, the distributed layout management unit 505 determines using the FHS selection table 513. An example of the storage contents of the FHS selection table 513 and specific determination contents are illustrated in FIG. 11.

In a case where it is determined that the comparison target is suitable for the FHS (Yes in step S907), the distributed layout management unit 505 sets the comparison target to the FHS candidate disk (step S908). After the end of the process in step S908 or in a case where it is determined that the FHS candidate disk is suitable for the FHS (No in step S907), the distributed layout management unit 505 determines whether a comparison of all disks is completed for current FHS (step S909). In a case where there is a disk which is not yet compared (No in step S909), the distributed layout management unit 505 proceeds to the process of step S906.

On the other hand, in a case where the comparison of all disks is completed (Yes in step S909), the distributed layout management unit 505 sets the FHS candidate disk as the current FHS disk and updates the FHS selection table 513 and the distributed layout table 512 (step S910). The specific updated contents of the FHS selection table 513 are illustrated in FIG. 11. The distributed layout management unit 505 updates fields of a disk which becomes a HS for the distributed layout table 512.

Next, the distributed layout management unit 505 determines whether the predetermined number of FHSs is set already (step S911). Here, the predetermined number of FHSs is the number of FHSs to be acquired in the disk pool and the number of disks corresponding to the capacity to be used as the spare area set in the process in step S901. In a case where the predetermined number of FHSs is not yet set (No in step S911), the distributed layout management unit 505 proceeds to the process of step S905. On the other hand, in a case where the predetermined number of FHSs is set already (Yes in step S911), the distributed layout management unit 505 sets a confirmation target to the head FR-Unit in the FR-Band in order to obtain distribution of data disks for the current FR-Band (step S912). In a case where the current FR-Band is not the head in the FR-WideBand (No in step S904), the distributed layout management unit 505 also proceeds to the process of step S912.

As illustrated in FIG. 10, next, the distributed layout management unit 505 temporarily sets a candidate disk of the FR-Unit (step S1001). Here, a disk that can be set as the candidate disk of the FR-Unit is a disk that satisfies a condition that it is not yet used in the same FR-Band and is not selected as the same FR-Unit in the same FR-WideBand. There may be no disk satisfying the condition described above.

Then, the distributed layout management unit 505 determines whether the temporary setting is successful, that is, a disk satisfying the condition described above can be set (step S1002). In a case where the disk satisfying the condition described above may not be set (No in step S1002), the distributed layout management unit 505 searches a disk that can be set as current FR-Unit among the disks to be used for the FR-Unit already set in the same FR-Band and replaces with the disk (step S1003). Then, the distributed layout management unit 505 updates again a distributed management table according to the replacement (step S1004).

In a case where the disk satisfying the condition described above can be set (Yes in step S1002) or after the end of the process of step S1004, the distributed layout management unit 505 sets the next disk that can be set as the comparison target, and confirms the distributed management table 514 (step S1005). The distributed layout management unit 505 determines whether the comparison target is more suitable for the FR-Unit than the candidate disk (step S1006). Here, the distributed layout management unit 505 determines whether it is suitable for the FR-Unit by priority of two conditions in the following order.

A first condition: The number of combinations with another specified disk as the same FR-Unit in the same FR-WideBand is small through distributed layout.

A second condition: A position from the last setting in the previous FR-WideBand to current FR-WideBand is far.

The distributed layout management unit 505 determines using the distributed management table 514 with respect to the two conditions described above. An example of the storage contents of the distributed management table 514 and a specific determination example are illustrated in FIGS. 12 and 13.

In a case where the comparison target is suitable for the FR-Unit (Yes in step S1006), the distributed layout management unit 505 changes current comparison target to the candidate disk of the FR-Unit (step S1007). After the end of the process of step S1007 or in a case where the candidate disk is suitable for the FR-Unit (No in step S1006), the distributed layout management unit 505 determines whether a comparison with all disks is completed for the current FR-Unit (step S1008). In a case where there is a disk that the comparison is not yet completed (No in step S1008), the distributed layout management unit 505 proceeds to the process of step S1005.

On the other hand, in a case where the comparison with all disks is completed (Yes in step S1008), the distributed layout management unit 505 sets the candidate disk to a disk to be used for the current FR-Unit, updates the distributed management table 514 according to the set disk (step S1009). Next, the distributed layout management unit 505 determines whether a disk of the predetermined number of FR-Units is set already for the current FR-Band (step S1010). Here, the predetermined number is a value obtained by subtracting the number of disks corresponding to the capacity to be used as the spare area from the number of disks to be used set by the process in step S901.

In a case where the disk of the predetermined number of FR-Units is not set yet (No in step S1010), the distributed layout management unit 505 changes a setting target to the next FR-Unit (step S1011). Then, the distributed layout management unit 505 proceeds to the process of step S1001.

On the other hand, In a case where the disk of the predetermined number of FR-Units is set already (Yes in step S1010), the distributed layout management unit 505 reflects setting information other than a FHS of the FR-Band in the distributed layout table 512, and changes the setting target to the next FR-Band (step S1012). Then, the distributed layout management unit 505 determines whether a FR-Band used for determining the distributed layout is set already as the predetermined number (step S1013). In a case where the FR-Band used for determining the distributed layout is not set yet (No in step S1013), the distributed layout management unit 505 proceeds to the process of step S904.

On the other hand, in a case where the FR-Band used for determining the distributed layout is set already (Yes in step S1013), the distributed layout management unit 505 releases the work buffer (step S1014). Then, the distributed layout management unit 505 ends the disk pool creation process.

FIG. 11 is an explanatory diagram illustrating an example of storage contents of a FHS selection table 513. The FHS selection table 513 includes a table 1101 that manages the number of FHS settings, a table 1102 that manages the number of FHS setting combinations, and a table 1103 that manages a position from the last setting as a FHS.

The table 1101 stores the number of times set as the FHS for each disk. For example, the table 1101 illustrated in FIG. 11 illustrates an example in which disks 203#0 to #3 are set once as the FHS. The distributed layout management unit 505 compares the number of settings between the FHS candidate disk and the comparison target with reference to the table 1101 as the first condition of the process of step S907.

When the plurality of FHSs exist, the table 1102 stores the number of combinations with another FHS in the same FR-WideBand. For example, the table 1102 illustrated in FIG. 11 indicates that combination of the disks 203#0 and #1 and combination of the disks 203#2 and #3 are set once as the FHS. The distributed layout management unit 505 (illustrated in FIG. 5) acquires a row of the FHS candidate disk and a row of the comparison target with reference to the table 1102 as the second condition of the process of step S907. After acquiring the two rows, the distributed layout management unit 505 compares numeral values in the vertical direction of the acquired two rows.

The table 1103 stores the number of times not set as the FHS from the last setting as the FHS in the previous FR-WideBand as the position from the last setting in the previous FR-WideBand to the current FR-WideBand. For example, the table 1103 illustrated in FIG. 11 indicates that the number of times not set as the FHS from the last setting as the FHS in the previous FR-WideBand is zero for the disks 203#0 and #1, one for the disks 203#2 and #3, and two for disks 203#4 and #5. The distributed layout management unit 505 compares the number between the FHS candidate disk and the comparison target with reference to the table 1103 as the third condition of the process of step S907.

As an update timing of the tables 1101 to 1103, the distributed layout management unit 505 updates the tables 1101 and 1102 in the process of step S910. The distributed layout management unit 505 updates the table 1103 after the process of step S911 is Yes. Specifically, the distributed layout management unit 505 clears the number of disks 203 selected as the FHS to zero and increments the number of disks 203 not selected as the FHS by one for the table 1103.

FIG. 12 is an explanatory example (part 1) illustrating update examples of the distributed layout table 512 and a distributed management table 514 in a disk pool process. FIG. 13 is an explanatory example (part 2) illustrating update examples of the distributed layout table 512 and the distributed management table 514 in the disk pool process.

In FIGS. 12 and 13, it is assumed that there are six disks 203, three redundancy members, and one FHS. The storage unit 510 illustrated in FIGS. 12 and 13 illustrates the distributed layout table 512 and the distributed management table 514. The distributed management table 514 includes a table 1201 that manages combination between disks and a table 1202 that manages an appearance frequency of the combination between disks. Rows of the tables 1201 and 1202 indicate reference disks 203, and columns indicate target disks 203. In FIGS. 12 and 13, parts to which hatching is assigned indicate that the update is performed. “FF” in the table 1202 of FIG. 12 is 0xFF and indicates an invalid value.

Since the FR-Band#0 is located at the head of the FR-WideBand, the distributed layout management unit 505 does not consider the combination between disks in the FR-WideBand.

The storage unit 510 illustrated in the upper part of FIG. 12 indicates update situations of the distributed layout table 512 and the distributed management table 514 during distributed layout creation of FR-Band#1. The distributed layout management unit 505 updates the table 1201 as the update of the distributed management table 514 in the process of step S1009. As a specific update example of the table 1201, focusing on rows of the distributed pattern numbers #0 and #1 of the distributed layout table 512, FR-Units #0 and #4 are disposed in disk 203#1. FR-Unit#0 is disposed also in disk 203#2, and FR-Unit#4 is disposed also in disk 203#5. Accordingly, as the update of the distributed management table 514 in the process of step S1009, the distributed layout management unit 505 increments the disks 203#2 and #5 by one for the row of the disk 203#1 of the table 1201.

The storage unit 510 illustrated in the lower part of FIG. 12 indicates update situations of the distributed layout table 512 and the distributed management table 514 during distributed layout creation of FR-Band#2. The distributed layout management unit 505 updates the table 1202 at the time of the end of the process of step S1012, that is, at the time of the end of the FR-WideBand process for the table 1202. As a specific update method of the table 1202, the distributed layout management unit 505 increments fields of table 1202 corresponding to fields incremented by one or more with combination of respective disks 203 of the table 1201 by one. In the storage unit 510 illustrated in the lower part of FIG. 12, since all fields not related to the disk#0 of the table 1201 are incremented by one or more, the distributed layout management unit 505 increments all fields not related to the disk#0 of the table 1202 by one.

The storage unit 510 illustrated in the upper part of FIG. 13 indicates update situations of the distributed layout table 512 and the distributed management table 514 during distributed layout creation of FR-Band#4. Since a specific update method of the distributed management table 514 is the same as the upper part of FIG. 12, the description will be omitted.

The storage unit 510 illustrated in the lower part of FIG. 13 indicates update situations of the distributed layout table 512 and the distributed management table 514 during distributed layout creation of FR-Band#5. Since a specific update method of the distributed management table 514 is the same as the upper part of FIG. 12, the description will be omitted.

The distributed layout management unit 505 places priority on a disk in which a value in the table 1201 is small in the first condition, and places the priority on a disk in which the value in the table 1201 is large in the second condition for the process of step S1006.

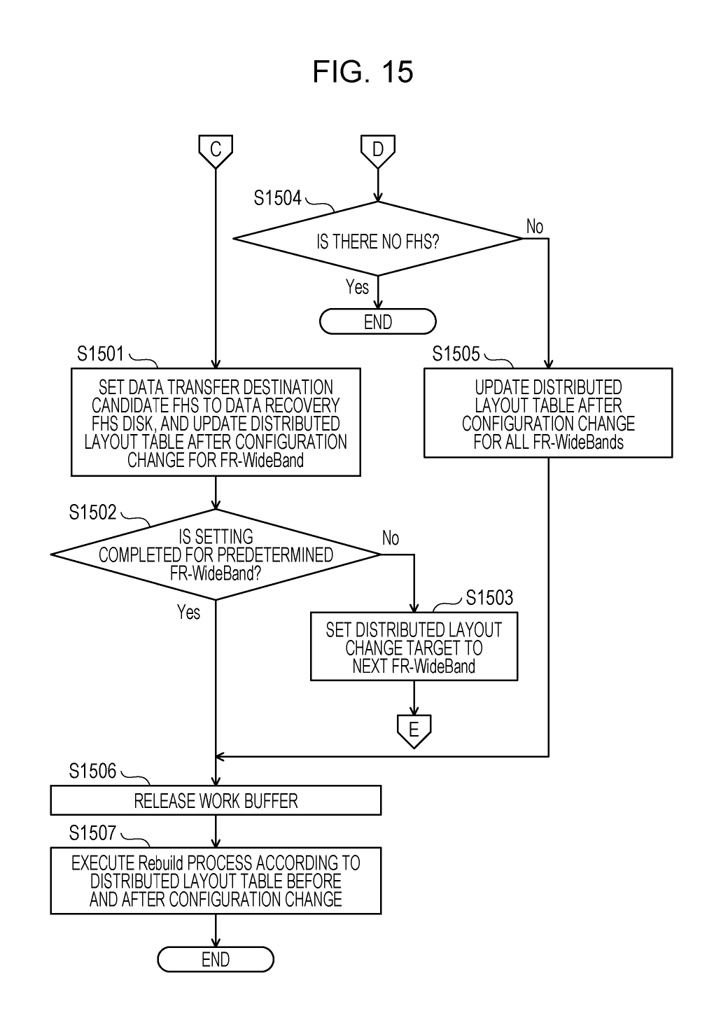

FIG. 14 is a flowchart (part 1) illustrating an example of a Rebuild process procedure with respect to FIG. 5. FIG. 15 is a flowchart (part 2) illustrating an example of the Rebuild process procedure with respect to FIG. 5. The configuration management unit 502 detects a disk failure occurrence or the CM 201 accepts an operation of a disk reduction from the administrator terminal 204 (step S1401).

Next, the distributed layout management unit 505 acquires the work buffer used for the distributed layout creation on the cache memory 303, and creates and initializes the distributed management table 514 (step S1402). Here, the distributed layout management unit 505 creates three distributed management tables 514. A first distributed management table 514 is referred to as a first comparison distributed management table 514, a second distributed management table 514 is referred to as a second comparison distributed management table 514, and a third distributed management table 514 is referred to as a backup distributed management table 514. In the Rebuild process, since the FHS setting is not performed, the FHS selection table 513 is not created. Thereafter, the distributed layout management unit 505 controls the flow before the Rebuild start.

The distributed layout management unit 505 determines whether a plurality of FHSs exist in the disk pool (step S1403). In a case where the plurality of FHSs exist in the disk pool (Yes in step S1403), the distributed layout management unit 505 sets a distributed layout change target to the FR-WideBand (step S1404). Next, the distributed layout management unit 505 saves the contents of current first comparison distributed management table 514 in the backup distributed management table 514, and copies the contents of the backup distributed management table 514 to the second comparison distributed management table 514 (step S1405). Then, the distributed layout management unit 505 temporarily sets a data transfer destination candidate FHS and updates the first comparison distributed management table 514 (step S1406).

Next, the distributed layout management unit 505 sets the comparison target to the next FHS and updates the second comparison distributed management table 514 (step S1407). Then, the distributed layout management unit 505 determines whether the comparison target is more suitable for a data recovery destination FHS than current data recovery destination candidate FHS (step S1408). Here, the distributed layout management unit 505 determines whether it is suitable for the data recovery destination FHS by priority of two conditions in the following order.

A first condition: The number of combinations with another disk as the same FR-Unit in the same FR-WideBand is small through distributed layout.

A second condition: A position from the last selection in the previous FR-WideBand to current FR-WideBand is far.

The distributed layout management unit 505 determines using the distributed management table 514 with respect to the two conditions described above. For example, in the process of step S1406, the distributed layout management unit 505 counts the number of items in which a value is improved in a table 1201 of the first comparison distributed management table 514, that is, the number of items in which the value becomes small by temporarily setting the data transfer destination candidate FHS. Similarly, in the process of step S1406, the distributed layout management unit 505 counts the number of items in which a value becomes small in a table 1201 of the second comparison distributed management table 514 by temporarily setting the comparison target. Then, as the first condition, the distributed layout management unit 505 compares the number of data transfer destination candidate FHSs with the number of comparison targets.

In a case where the comparison target is suitable for the data recovery destination FHS (Yes in step S1408), the distributed layout management unit 505 regards the comparison target as a data transfer destination FHS candidate disk, and replaces the first comparison distributed management table and the second comparison distributed management table with each other (step S1409). After the end of the process in step S1409 or in a case where the comparison target is not suitable for the data recovery destination FHS (No in step S1408), the distributed layout management unit 505 determines whether a comparison with all FHSs is completed (step S1410). In a case where there is a FHS in which the comparison is not completed (No in step S1410), the distributed layout management unit 505 copies the contents of the backup distributed management table to the second comparison distributed management table (step S1411). Then, the distributed layout management unit 505 proceeds to the process of step S1407.

On the other hand, in a case where the comparison with all FHSs is completed (Yes in step S1410), the distributed layout management unit 505 sets the data transfer destination candidate FHS to a data recovery FHS disk, and updates the distributed layout table 512 after the configuration change for the FR-WideBand (step S1501). Next, the distributed layout management unit 505 determines whether the setting of the data recovery FHS disk is completed for all FR-WideBands used for determining the distributed layout as a predetermined FR-WideBand (step S1502). In a case where there is a FR-WideBand in which the setting of the data recovery FHS disk is not completed (No in step S1502), the distributed layout management unit 505 sets the distributed layout change target to the next FR-WideBand (step S1503). Then, the distributed layout management unit 505 proceeds to the process of step S1405.

In a case where the plurality of FHSs do not exist in the disk pool (No in step S1403), the distributed layout management unit 505 determines whether there is no FHS in the disk pool (step S1504). In a case where there is no FHS in the disk pool (Yes in step S1504), since the data recovery may not be performed, the distributed layout management unit 505 ends the Rebuild process.

On the other hand, in a case where there is a FHS in the disk pool (No in step S1504), the distributed layout management unit 505 updates the distributed layout table 512 after the configuration change for all FR-WideBands (step S1505).

After the end of the process of step S1505 or in a case where the setting of the data recovery FHS disk is completed (Yes in step S1502), the distributed layout management unit 505 releases the work buffer (step S1506). Then, the RAID Recovery control unit 506 executes the Rebuild process according to the distributed layout table 512 before and after the configuration change (step S1507). After the end of the process of step S1507, the CM 201 ends the Rebuild process.

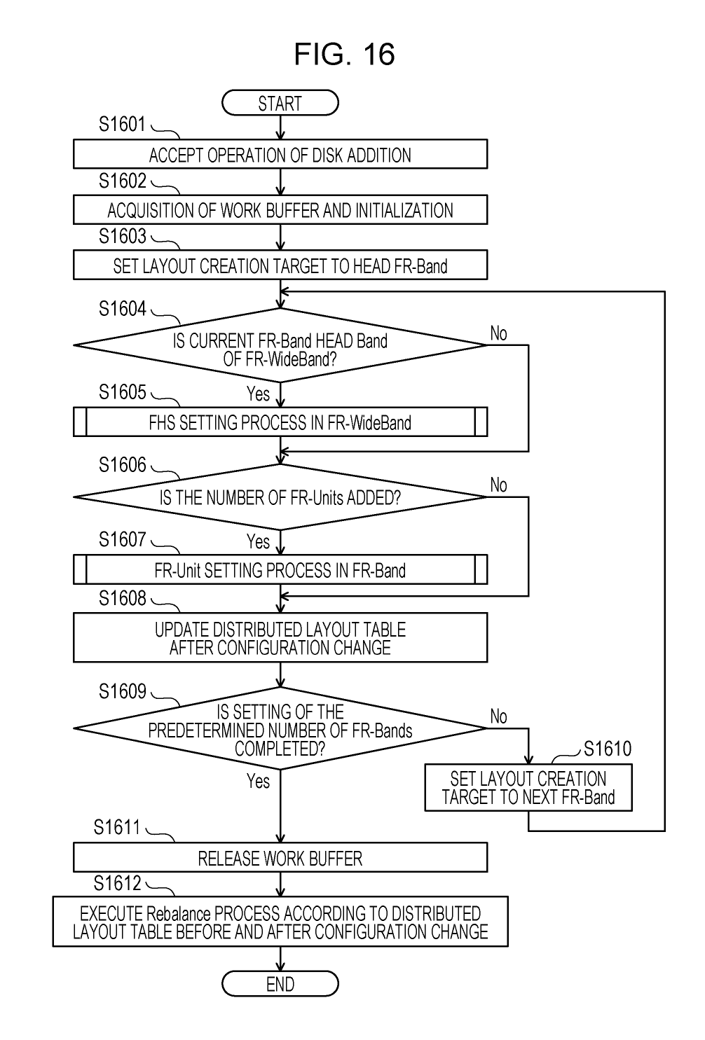

FIG. 16 is a flowchart illustrating an example of a disk addition process procedure with respect to FIGS. 2, 3, and 5. The CM 201 accepts an operation of disk addition from the administrator terminal 204 (step S1601). At the time, the administrator terminal 204 displays input items by the management GUI on the display of the administrator terminal 204. The input items are items for inputting the number of disks to be added, the number of disks corresponding to the capacity to be used as the spare area. In the administrator terminal 204, all the input items may be input by the administrator Ad or specified values may be set in advance in the input items.

Next, the distributed layout management unit 505 acquires the work buffer used for distributed layout creation on the cache memory 303, and creates and initializes the FHS selection table 513 and the distributed management table 514 (step S1602). Here, the distributed layout management unit 505 creates two FHS selection tables 513 and three distributed management tables 514. A first FHS selection table 513 is referred to as a first comparison FHS selection table 513, a second FHS selection table 513 is referred to as a second comparison FHS selection table 513. A first distributed management table 514 is referred to as a first comparison distributed management table 514, a second distributed management table 514 is referred to as a second comparison distributed management table 514, and a third distributed management table 514 is referred to as a backup distributed management table 514. Thereafter, the distributed layout management unit 505 controls the flow until the process completion.

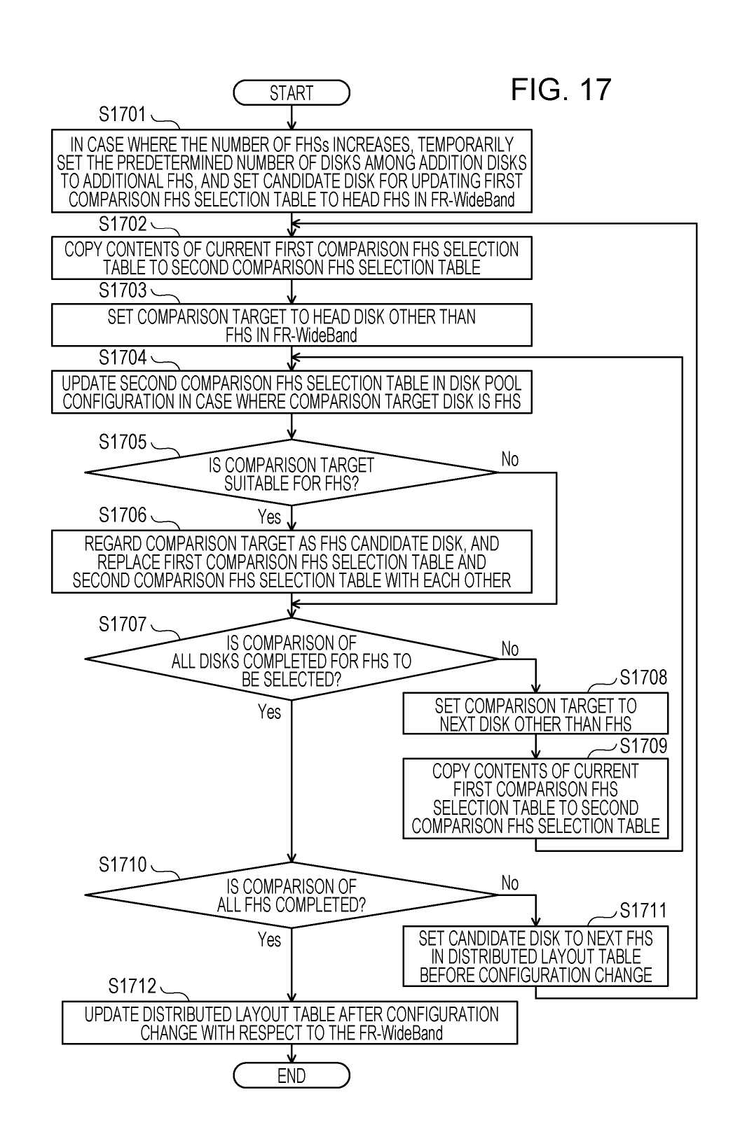

Then, the distributed layout management unit 505 sets a layout creation target to the head FR-Band (step S1603). Next, the distributed layout management unit 505 determines whether current FR-Band is the head Band of FR-WideBand (step S1604). In a case where the current FR-Band is the head Band of FR-WideBand (Yes in step S1604), the distributed layout management unit 505 executes a FHS setting process procedure in FR-WideBand (step S1605). The FHS setting process will be described in FIG. 17.

After the end of the process in step S1605 or in a case where the current FR-Band is not the head Band of FR-WideBand (No in step S1604), the distributed layout management unit 505 determines whether the number of the FR-Units is added by current disk addition (step S1606). Here, a case where the number of the FR-Units is added is a case where a value obtained by subtracting the number of disks corresponding to the capacity to be used as the spare area from the number of disks to be added obtained by the process in step S1601 is one or more.

In the case where the number of the FR-Units is added (Yes in step S1606), the distributed layout management unit 505 executes the FR-Unit setting process in FR-Band (step S1607). The FR-Unit setting process in FR-Band will be described in FIG. 18.

After the end of the process in step S1607 or in a case where the number of the FR-Units is not added (No in step S1606), the distributed layout management unit 505 updates the distributed layout table 512 after the configuration change for the current FR-Band (step S1608). Next, the distributed layout management unit 505 determines whether setting of all FR-Bands used for determining the distributed layout is completed as the predetermined number of FR-Bands (step S1609). In a case where the setting of all FR-Bands used for determining the distributed layout is not completed (No in step S1609), the distributed layout management unit 505 sets the layout creation target to the next FR-Band (step S1610). Then the distributed layout management unit 505 proceeds to the process of step S1604.

On the other hand, in a case where the setting of all FR-Bands used for determining the distributed layout is completed (Yes in step S1609), the distributed layout management unit 505 releases the work buffer (step S1611). Next, the RAID Recovery control unit 506 executes the Rebalance process according to the distributed layout table before and after the configuration change (step S1612). After the end of the process of step S1612, the CM 201 ends the disk addition process procedure.

FIG. 17 is a flowchart illustrating an example of a FHS setting process procedure in FR-WideBand with respect to FIG. 5. In a case where the number of FHSs is increased by an added disk, the distributed layout management unit 505 temporarily sets the predetermined number of disks among the addition disks to an additional FHS, and sets a candidate disk for updating the first comparison FHS selection table 513 to the head FHS in FR-WideBand (step S1701). Next, the distributed layout management unit 505 copies the contents of current first comparison FHS selection table 513 to the second comparison FHS selection table 513 (step S1702). Since an evaluation of individual FHS is performed after temporarily setting all FHSs to which a plurality of numbers are added, the distributed layout management unit 505 copies to the second comparison FHS selection table 513 after updating of the first comparison FHS selection table 513. At the time of performing the copy, the second comparison FHS selection table 513 is in a state where a temporary setting situation of FHS of current FR-WideBand is reflected in addition to a FHS disposition situation determined by FR-WideBand so far.

Then, the distributed layout management unit 505 sets the head FHS of already existing FHSs among the current FR-WideBands to a candidate and sets the comparison target to the head disk which is not the FHS in the same FR-WideBand (step S1703). Here, the disk which is not the FHS is a disk in which data exists.

Next, the distributed layout management unit 505 updates the second comparison FHS selection table 513 in a disk pool configuration in a case where a comparison target disk is a FHS (step S1704). Here, at the time of updating, the distributed layout management unit 505 performs subtraction of the candidate FHS in addition to addition of the comparison target FHS.

Then, the distributed layout management unit 505 determines whether the comparison target is more suitable for the FHS than the candidate disk with reference to the first comparison FHS selection table 513 and the second comparison FHS selection table 513 (step S1705). Here, the method of determining whether it is suitable for the FHS is the same as the method described in the process of step S907 illustrated in FIG. 9.

In a case where the comparison target is suitable for the FHS (Yes in step S1705), the distributed layout management unit 505 regards the comparison target as the FHS candidate disk, and replaces the first comparison FHS selection table and the second comparison FHS selection table with each other (step S1706).

After the end of the process in step S1706 or in a case where the candidate disk is suitable for the FHS (No in step S1705), the distributed layout management unit 505 determines whether the comparison of all disks is completed for the FHS to be selected (step S1707). In a case where there is a disk in which the comparison is not completed for the FHS to be selected (No in step S1707), the distributed layout management unit 505 sets the comparison target to the next disk which is not the FHS in the same FR-WideBand (step S1708). Next, the distributed layout management unit 505 copies the contents of current first comparison FHS selection table 513 to the second comparison FHS selection table 513 (step S1709). Then, the distributed layout management unit 505 proceeds to the process of step S1704.

On the other hand, in a case where the comparison of all disks is completed for the FHS to be selected (Yes in step S1707), the distributed layout management unit 505 determines whether the comparison of all FHSs is completed (step S1710). In a case where there is a FHS in which the comparison is not completed (No in step S1710), the distributed layout management unit 505 sets the candidate disk to the next FHS in the distributed layout table before the configuration change (step S1711). Then, the distributed layout management unit 505 proceeds to the process of step S1702. On the other hand, in a case where the comparison of all FHSs is completed (Yes in step S1710), the distributed layout management unit 505 updates the distributed layout table 512 after the configuration change with respect to the FR-WideBand (step S1712). After the end of the process of step S1712, the distributed layout management unit 505 ends the FHS setting process procedure in FR-WideBand.

FIG. 18 is a flowchart illustrating an example of a FR-Unit setting process procedure in FR-Band with respect to FIG. 5. The distributed layout management unit 505 temporarily sets the head among unused disks as a candidate of the head FR-Unit to be added (step S1801). Here, the unused disks are the disks added in the process in step S1601 illustrated in FIG. 16. A disk that can be set as the candidate disk of the FR-Unit is a disk that satisfies a condition that the same disk is not used already for a Depth of the same FR-Unit within the same FR-WideBand. There may be no disk satisfying the condition described above.

Next, the distributed layout management unit 505 determines whether the temporary setting is successful, that is, a disk satisfying the condition described above can be set (step S1802). In a case where the temporary setting is not successful (No in step S1802), the distributed layout management unit 505 replaces with the disk that can be set among the disks to be used for the FR-Unit already set in the same FR-Band (step S1803).

In a case where the temporary setting is successful (Yes in step S1802), the distributed layout management unit 505 saves the contents of the current first comparison distributed management table in the backup distributed management table 514, and copies the contents of the backup distributed management table 514 to the second comparison distributed management table 514 (step S1804). After the end of the process of step S1803, the distributed layout management unit 505 also proceeds to the process of step S1804.

After the end of the process of step S1804, the distributed layout management unit 505 updates the first comparison distributed management table 514 according to the temporary setting (step S1805). Next, the distributed layout management unit 505 sets the comparison target to the next disk that can be set, and updates the second comparison distributed management table 514 (step S1806). Here, the disk that can be set has the same condition described in the process of step S1801.

Then, the distributed layout management unit 505 determines whether the comparison target is more suitable for FR-Unit than the candidate disk with reference to the first comparison distributed management table 514 and the second comparison distributed management table 514 (step S1807). Here, the method of determining whether it is suitable for the FR-Unit is the same as the method described in the process of step S1006 illustrated in FIG. 10.

In a case where the comparison target is more suitable for the FR-Unit than the candidate disk (Yes in step S1807), the distributed layout management unit 505 regards the comparison target as a data transfer destination FHS candidate disk, and replaces the first comparison distributed management table and the second comparison distributed management table with each other (step S1808).

After the end of the process of step S1808 or in a case where the comparison target is not more suitable for the FR-Unit than the candidate disk (No in step S1807), the distributed layout management unit 505 determines whether a comparison with all disks is completed for current FR-Unit (step S1809). In a case where there is a disk that the comparison is not yet completed (No in step S1809), the distributed layout management unit 505 copies the contents of the backup distributed management table 514 to the second comparison distributed management table 514 (step S1810). The distributed layout management unit 505 proceeds to the process of step S1806.

On the other hand, in a case where the comparison with all disks is completed (Yes in step S1809), the distributed layout management unit 505 determines whether a process of the predetermined number of FR-Units is completed for the current FR-Band (step S1811). In a case where the process of the predetermined number of FR-Units is not completed (No in step S1811), the distributed layout management unit 505 temporarily sets the head among the unused disks as a candidate of the next FR-Unit to be added (step S1812). Then, the distributed layout management unit 505 proceeds to the process of step S1802.

On the other hands, in a case where the process of the predetermined number of FR-Units is completed (Yes in step S1811), the distributed layout management unit 505 ends the FR-Unit setting process in FR-Band.

FIG. 19 is an explanatory diagram illustrating an example of a disk pool configuration in which configuration components of a redundancy set are disposed at the same position on disks. As the first method illustrated in FIG. 1, FIG. 19 is the example in which the configuration components of the redundancy set are disposed at the same position on each disk. For example, data of row#7 of disk#0, data of the row#7 of disk#1, data of the row#7 of disk#2, and data of the row#7 of disk#5 are one redundancy set as filled data.

FIG. 20 is an explanatory diagram illustrating an example of a disk pool configuration in which configuration components of a redundancy set are managed by a disk number and a position on a disk. As the second method illustrated in FIG. 1, FIG. 20 is the example in which the configuration components of the redundancy set are managed by the disk number and the position on the disk. For example, data of row#6 of disk#0, data of the row#2 of disk#2, data of the row#5 of disk#5, and data of the row#1 of disk#8 are one redundancy set as data to which hatching of horizontal lines is assigned. Respective data illustrated in FIG. 20 are displayed larger than in FIG. 19, and it indicates that a size of the redundancy set is large.

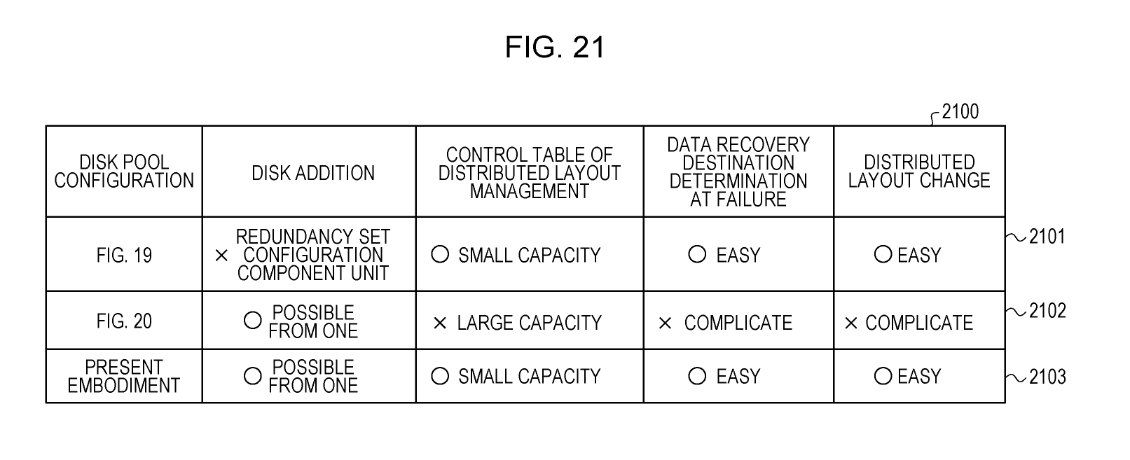

FIG. 21 is an explanatory diagram illustrating an example of effects according to the present embodiment. A table 2100 illustrated in FIG. 21 is a table that summarizes features of the first method illustrated in FIG. 1 indicated by record 2101, the second method illustrated in FIG. 1 indicated by record 2102, and the method according to the present embodiment indicated by record 2103.

In the first method, the capacity of the table area for the control table of the distributed layout management is small, the data recovery destination determination at failure is easy, and the distributed layout change is easy, but the disk addition becomes a redundancy set configuration component unit.

In the second method, the disk can be added from one, but the capacity of the table area for the control table of the distributed layout management is large, the data recovery destination determination at failure is complicate, and the distributed layout change is complicate.

In the method according to the present embodiment, the disk can be added from one, the capacity of the table area for the control table of the distributed layout management is small, the data recovery destination determination at failure is easy, and the distributed layout change is easy. As described above, the method according to the present embodiment is more effective than the first method and the second method.

As described above, when a new disk 203 is added to the disk pool configuration, the CM 201 transfers the data of different rows from the redundancy set corresponding to the number of divisions in the FR-WideBand to the new disk 203. As a result, the CM 201 can minimize the data transfer during the disk pool configuration change.

When the data of different rows are selected from the redundancy set corresponding to the number of divisions, the CM 201 may be based on the number of combinations between the disk 203 in which the data is disposed and the disk 203 in which each FR-Unit disposed in the plurality of disks 203 is disposed. As a result, since the data is distributed more uniformly, the CM 201 distributes more the reading destination during the next Rebuild process, and can reduce the time taken for the Rebuild process.

When performing the Rebuild process, the CM 201 recovers the data stored in the failed disk 203 or the reduction target disk 203 to the FR-Depth on the FHS and the same row as the data based on the FR-Unit including the data. As a result, the CM 201 can recover the data without losing the redundancy.

In the case where there are two or more FHSs, the CM 201 may specify the number of combinations between disks 203 in which each FR-Unit disposed in the plurality of disks 203 in the state after recovering the data in each FHS of the two or more FHSs is disposed corresponding to the two or more FHSs. As a result, since it is possible to recover the data without losing the redundancy and to distribute the data more uniformly, the CM 201 distributes more the reading destination during the next Rebuild process, and can reduce the time taken for the Rebuild process.

The storage control method described in the present embodiment can be realized by causing the computer such as a personal computer or a workstation to execute a program prepared in advance. The storage control program is recorded in a computer-readable recording medium such as a hard disk, a flexible disk, a compact disc-read only memory (CD-ROM), and a digital versatile disk (DVD), and is executed by being read from the recording medium by the computer. The storage control program may be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A storage control apparatus comprising:
a memory; and
a processor coupled to the memory, the processor configured to:
upon determination to perform a distributed layout change in which a new storage or a hot-spare storage to be a hot spare is added to a plurality of storages, in a state where redundancy datasets each including two or more pieces of data which ensure redundancy of the data are stored in the plurality of storages so that the two or more pieces of data are respectively disposed on different storages of the plurality of storages and respectively disposed at different physical addresses within a physical address range that is allocated in common to each of the plurality of storages, the different physical addresses being obtained by dividing the physical address range according to a data size of each of the two or more pieces of data, select, from among the redundancy datasets, a first redundancy dataset including two or more pieces of first data that are respectively disposed on first different storages of the plurality of storages and respectively disposed at first different physical addresses within the physical address range, and
transfer the two or more pieces of first data included in the selected first redundancy dataset to second different physical addresses on the new storage or the hot-spare storage, respectively, so that the second different physical addresses are identical to the first different physical addresses within the physical address range allocated to the plurality of storages.

2. The storage control apparatus according to claim 1,
wherein the processor is configured to, upon determining to perform the distributed layout change, select the two or more pieces of first data included in the first redundancy dataset, based on a number of combinations between a first storage in which one of the two or more pieces of first data is disposed and a second storage that allows another one of the two or more pieces of first data to be stored therein.

3. The storage control apparatus according to claim 1,
wherein the processor is configured to:
detect a failed storage among the plurality of storages or accept an instruction to remove a reduction target storage from the plurality of storages, in a state where a hot-spare area to be a recovery destination of any one of two or more pieces of data included in the redundancy datasets is disposed within the physical address range allocated to one of the plurality of storages, and
recover one of two or more pieces of second data included in a second redundancy dataset that has been stored in the failed storage or the reduction target storage to a physical address within the hot-spare area, which is identical to a physical address at which the one of the two or more pieces of second data has been disposed, based on the second redundancy dataset including the one of the two or more pieces of second data.

4. The storage control apparatus according to claim 3,
wherein the processor is configured to:
detect a failed storage among the plurality of storages or accept an instruction to remove a reduction target storage from the plurality of storages, in a state where a hot spare area to be a recovery destination of any piece of data included in the redundancy datasets disposed within the physical address range of the plurality of storages is disposed within the physical address range allocated to two or more storages of the plurality of storages,
count a number of combinations between storages among the plurality of storages, which allow two or more pieces of data included in the redundancy datasets to be disposed therein in a state after recovering, to each of the two or more storages, one of two or more pieces of second data included in a second redundancy dataset that has been stored in the failed storage or the reduction target storage data,
determine a recovery destination storage from among the two or more storages, based on the counted number of combinations, and
recover the one of the two or more pieces of second data included in the second redundancy dataset, that has been stored in the failed storage or the reduction target storage, to a physical address of the determined recovery destination storage, which is identical to a physical address at which the one of the two or more pieces of second data has been disposed in the failed storage or the reduction target storage.

5. A storage control method comprising:
upon determination to perform a distributed layout change in which a new storage or a hot-spare storage to be a hot spare is added to a plurality of storages, in a state where redundancy datasets each including two or more pieces of data which ensure redundancy of the data are stored in the plurality of storages so that the two or more pieces of data are respectively disposed on different storages of the plurality of storages and respectively disposed at different physical addresses within a physical address range that is allocated in common to each of the plurality of storages, the different physical addresses being obtained by dividing the physical address range according to a data size of each of the two or more pieces of data, selecting, from among the redundancy datasets, a first redundancy dataset including two or more pieces of first data that are respectively disposed on first different storages of the plurality of storages and respectively disposed at first different physical addresses within the physical address range; and
transferring the two or more pieces of first data included in the selected first redundancy dataset to second different physical addresses on the new storage or the hot-spare storage, respectively, so that the second different physical addresses are identical to the first different physical addresses within the physical address range allocated to the plurality of storages.

6. The storage control method according to claim 5, further comprising:
detecting a failed storage among the plurality of storages or accept an instruction to remove a reduction target storage from the plurality of storages, in a state where a hot-spare area to be a recovery destination of any one of two or more pieces of data included in the redundancy datasets is disposed within the physical address range allocated to one of the plurality of storages; and
recovering one of two or more pieces of second data included in a second redundancy dataset that has been stored in the failed storage or the reduction target storage to a physical address within the hot-spare area, which is identical to a physical address at which the one of the two or more pieces of second data has been disposed, based on the second redundancy dataset including the one of the two or more pieces of second data.

7. A non-transitory, computer-readable recording medium having stored therein a program for causing a computer to execute a process comprising:
upon determination to perform a distributed layout change in which a new storage or a hot-spare storage to be a hot spare is added to a plurality of storages, in a state where redundancy datasets each including two or more pieces of data which ensure redundancy of the data are stored in the plurality of storages so that the two or more pieces of data are respectively disposed on different storages of the plurality of storages and respectively disposed at different physical addresses within a physical address range that is allocated in common to each of the plurality of storages, the different physical addresses being obtained by dividing the physical address range according to a data size of each of the two or more pieces of data, selecting, from among the redundancy datasets, a first redundancy dataset including two or more pieces of first data that are respectively disposed on first different storages of the plurality of storages and respectively disposed at first different physical addresses within the physical address range; and
transferring the two or more pieces of first data included in the selected first redundancy dataset to second different physical addresses on the new storage or the hot-spare storage, respectively, so that the second different physical addresses are identical to the first different physical addresses within the physical address range allocated to the plurality of storages.

8. The non-transitory, computer-readable recording medium according to claim 7, the process further comprising:
detecting a failed storage among the plurality of storages or accept an instruction to remove a reduction target storage from the plurality of storages, in a state where a hot-spare area to be a recovery destination of any one of two or more pieces of data included in the redundancy datasets is disposed within the physical address range allocated to one of the plurality of storages; and
recovering one of two or more pieces of second data included in a second redundancy dataset that has been stored in the failed storage or the reduction target storage to a physical address within the hot-spare area, which is identical to a physical address at which the one of the two or more pieces of second data has been disposed, based on the second redundancy dataset including the one of the two or more pieces of second data.

9. A storage control apparatus comprising:
a memory configured to store instructions; and
a processor coupled to the memory and that executes the instructions causing a process of:
storing recovery data of a fast recovery portion of storage data in different portions of a plurality of storages;
storing the recovery data in different fast recovery bands within a physical address range of each of the plurality of storages, the physical address range being divided according to a size of the fast recovery portion; and
transferring recovery data having different addresses from a redundancy set corresponding to a number of divisions in the physical address range to data transfer target storage.

10. A storage control apparatus comprising:
a memory configured to store instructions; and
a processor coupled to the memory and that executes the instructions causing a process of:
storing recovery data of a fast recovery portion of storage data in different portions of a plurality of storages;
storing the recovery data in different fast recovery bands within a physical address range of each of the plurality of storages, the physical address range being divided according to a size of the fast recovery portion;
accepting an instruction to add a new storage;
determining whether to perform a distributed layout change of the storage data with the new storage;
selecting transfer data from the physical address range and in the different fast recovery bands corresponding to each fast recovery portion when a determination is made to perform the distributed layout change; and
transferring the transfer data to the new storage.
